(19) United States
(12) Patent Application Publication
(10) Pub. No.: US 2004/0123744 A1
(43) Pub. Date: Jul. 1, 2004

(54) Dual level waffle iron

(76) Inventor: Thomas B. Bobo, Las Vegas, NV (US)

Correspondence Address: BAKER & DANIELS, 205 W. JEFFERSON BOULEVARD, SUITE 250, SOUTH BEND, IN, 46601, US

(21) Appl. No.: 10/737,291

(22) Filed: Dec. 16, 2003

Related U.S. Application Data
(60) Provisional application No. 60/433,911, filed on Dec. 17, 2002.

(51) Int. Cl. A47J 9/00

(52) U.S. Cl. 99/374; 99/372

(57) ABSTRACT

A dual level waffle iron having a central waffle iron section, a first cover member, and a second cover member. The central waffle iron section and each of the cover members includes a grid array having a cavities and channels connecting the cavities. The central waffle iron section rotates about the longitudinal axis of the dual level waffle iron and further includes pins for preventing the central waffle iron section for rotating unless desired. The cover members further include an adjustment mechanism for varying the distance between the grid arrays in the cover member and the grid arrays in the central waffle iron section. A cutting tool for separating cooked waffles in the cavities is also provided along with a waffle batter dispenser for filling the cavities with waffle batter quickly and easily.

This application claims the benefit of U.S. Provisional Patent Application Serial No. 60/433,911 filed Dec. 17, 2002, the complete disclosure of which is hereby expressly incorporated by reference.

### BACKGROUND OF THE INVENTION

1. Field of the Invention

The present invention relates to a dual level waffle iron apparatus for cooking a plurality of waffles and the like. In addition, the present invention relates to a method of preparing a plurality of waffles utilizing the dual level waffle iron apparatus disclosed herein.

2. Description of Prior Art

Traditionally, the most common type of waffle iron apparatus utilized in the production of waffles or similar items consists of a single level, substantially horizontal waffle iron apparatus having a base member with a first grid array and a cover member with a second grid array. The cover member is affixed to the base member by way of a hinge allowing the cover member to close against the base member in what is commonly referred to as a clam shell closure. Furthermore, the cover member may be rotated open, in a similar manner, allowing waffle batter to be added to the grid array of the base member for the cooking of waffles therein.

A major disadvantage of the traditional single level, horizontal waffle iron apparatuses is the inability to meet high volume waffle demands in business applications, such as in banquet halls, restaurants, buffet lines, etc. In the past, attempts to overcome this difficulty required the utilization of a plurality of single level waffle irons with each requiring its own electrical connection. Additionally, the utilization of many waffle irons requires the operator to simultaneous monitor the cooking progress of all of the waffles contained within the many waffle irons, which may lead to over-cooked waffles that are no longer edible.

Another problem associated with using a plurality of the traditional single level waffle iron apparatuses for producing large quantities of waffles involves the buildup of the heat generated from the many individual waffles irons as the waffles are cooked within. Each waffle iron radiates heat as the waffles are cooking which, in a confined space such as a kitchen, will build up over time, increasing the air temperature and decreasing the comfort level within.

In response to these shortcomings, a dual level waffle iron apparatus including a grid with a plurality of cavities allowing for the preparation of a large number of waffles has been developed and disclosed in U.S. Pat. No. 5,768,994 granted to the named inventor of the present invention, the disclosure of which is expressly incorporated herein by reference. Although this dual level waffle apparatus overcomes many of the deficiencies associated with traditional waffle irons, it has raised new challenges. For example, the addition of a second level of grid arrays and waffle cavities requires that a portion of the apparatus be supported on a base and be rotatable about the waffles iron's longitudinal axis. Unfortunately, this need for rotation creates the possibility that the waffle iron may rotate unexpectedly while the operator is preparing the waffles.

Additionally, the above disclosed dual level waffle iron requires the operator to fill the numerous cavities of the grid arrays with precise amounts of waffle batter. Batter in overfilled waffle cavities may leak onto the grid array wasting batter and dirtying the grid, whereas under-filled cavities may produce waffles which are not cooked evenly on both sides.

Furthermore, both the dual level waffle iron apparatus and traditional single level waffle iron apparatuses, discussed above, utilize a type of hinge in connecting the cover member to the base member such that the cover member is always located at the same distance from the base member when in the closed position. This has the tendency to impede the expansion of the waffle batter as it cooks between the grids, which leads to harder, less fluffy waffles.

Thus, there exists a need for a multi-level waffle iron apparatus which provides for a large volume of waffles while also minimizing the problems associated with the prior art as discussed above, such as the production of waffles with various degrees of consistency and the potential danger associated with a rotating grid assembly.

### SUMMARY OF THE INVENTION

It is an object of this invention to provide an improved waffle iron apparatus and method for producing large quantities of waffles.

It is further an object of this invention to provide an improved multi-level waffle iron apparatus and method associated with its usage.

The objects of the invention have been accomplished by providing an improved multi-level waffle iron apparatus comprising a first horizontal level waffle iron assembly including a cover member and a base member and a second horizontal level waffle iron assembly also including a cover member and a base member. In addition, the base members of each of the waffle iron assemblies are located proximate each other. Furthermore, a grid array, including a plurality of waffle cavities, is located within each of the cover members and base members. The waffle iron apparatus also includes an adjustment mechanism allowing the cover member to move during cooking, vertically relative to the base member as necessary, while the waffle batter expands during cooking.

Another embodiment of the present invention provides for a multi-level waffle iron apparatus comprising grid arrays within the base member which include channels connecting every waffle cavity to all adjacent waffle cavities so as to allow the waffle batter in the cavities to self level ensuring that each cavity contains substantially the same amount of waffle batter.

An additional embodiment of the present invention provides for a multi-level waffle iron apparatus comprising a spring and pin mechanism which provides a means for preventing the unintended rotation of the waffle iron about its longitudinal axis, for the protection of the operator.

Further scope of the applicability of the present invention will become apparent from the detailed description contained herein. However, it should be understood that the detailed description and specific example, while indicating one embodiment of the invention, are given by way of illustration only, since various changes and modifications within the spirit and scope of the invention will become apparent to those skilled in the art, from this detailed description.

### BRIEF DESCRIPTION OF THE DRAWINGS

These and other features of the invention will become more apparent and the present invention will be better understood upon consideration of the following description and the accompanying drawings wherein:

FIG. 1 depicts a perspective view of a dual level waffle iron apparatus of the present invention;

FIG. 2A depicts the dual level waffle iron shown in FIG. 1 with a cover member located in the open position;

FIGS. 2B, 2C, and 2D depict alternative embodiments of the grid array used in the dual level waffle iron shown in FIG. 2A;

FIG. 3 depicts a side view of the hidden side of the dual level waffle iron shown in FIG. 1;

FIG. 4A shows a cross-sectional view of the latch assembly through lines 4A-4A of FIG. 1;

FIG. 4B depicts a side view of an alternative embodiment of the latch assembly utilized in the dual level waffle iron of the present invention of FIG. 4A;

FIG. 5 depicts a front view of the latch assembly shown in FIG. 4A;

FIG. 6 depicts a section view of the adjustment mechanism utilized in the dual level waffle iron of the present invention;

FIG. 7 depicts a rear perspective view of the dual level waffle iron of the present invention with the hinge cover removed;

FIG. 8 depicts a cutaway view of the rear side of the dual level waffle iron shown in FIG. 1;

FIG. 9 depicts a rear side view of the dual level waffle iron shown in FIG. 1;

FIG. 10 depicts a side view of the dual level waffle iron shown in FIG. 1;

FIG. 11 depicts a side view of the dual level waffle iron shown in FIG. 10 moved forward within its base, in order to allow for rotation about its longitudinal axis;

FIGS. 12A-12C depicts a perspective view of the dual level waffle iron shown in FIG. 11 rotating about its longitudinal axis;

FIGS. 13A-13D depicts a perspective view of the dual level waffle iron shown in FIG. 1 unloading waffles via rotation of a grid array about the connecting hinge;

FIG. 14 depicts a perspective view of a cutting tool used in accordance with the present invention;

FIG. 15 depicts an exploded perspective view of the cutting tool shown in FIG. 14;

FIG. 16 depicts a perspective view of a waffle batter dispenser used in accordance with the present invention;

FIG. 17 depicts a bottom plan view of the waffle batter dispenser shown in FIG. 16;

FIG. 18 depicts a sectional side view of the waffle batter dispenser shown in FIG. 16;

FIG. 19 depicts a section side view of the waffle batter dispenser shown in FIG. 16 as the waffle batter dispenser is arranged to dispense waffle batter;

FIG. 20 depicts a perspective view of the waffle batter dispenser shown in FIGS. 16-19 set up to dispense waffle batter onto the grid array of the dual level waffle iron;

FIG. 21 depicts a perspective view of an alternative embodiment of a waffle batter dispenser;

FIGS. 22 and 23 depict perspective views of the waffle batter dispenser shown in FIG. 21 mounted to the dual level waffle iron shown in FIG. 1;

FIG. 24 depicts a perspective view of a steam pan frame utilized in the present invention;

FIG. 25 depicts a perspective view of the cutting tool shown in FIGS. 15 and 16 separating waffles cooked in the dual level waffle iron shown in FIG. 1; and

FIGS. 26A and 26B depict a top view of an alternative embodiment of the adjustment arm which couples the waffle batter dispenser shown in FIG. 21 to the dual level waffle iron shown in FIG. 1.

### DETAILED DESCRIPTION OF THE EMBODIMENTS OF THE INVENTION

The embodiment of the invention described herein is not intended to be exhaustive nor to limit the invention to the precise forms disclosed. Rather, the embodiment selected for description has been chosen to enable one skilled in the art to practice the invention.

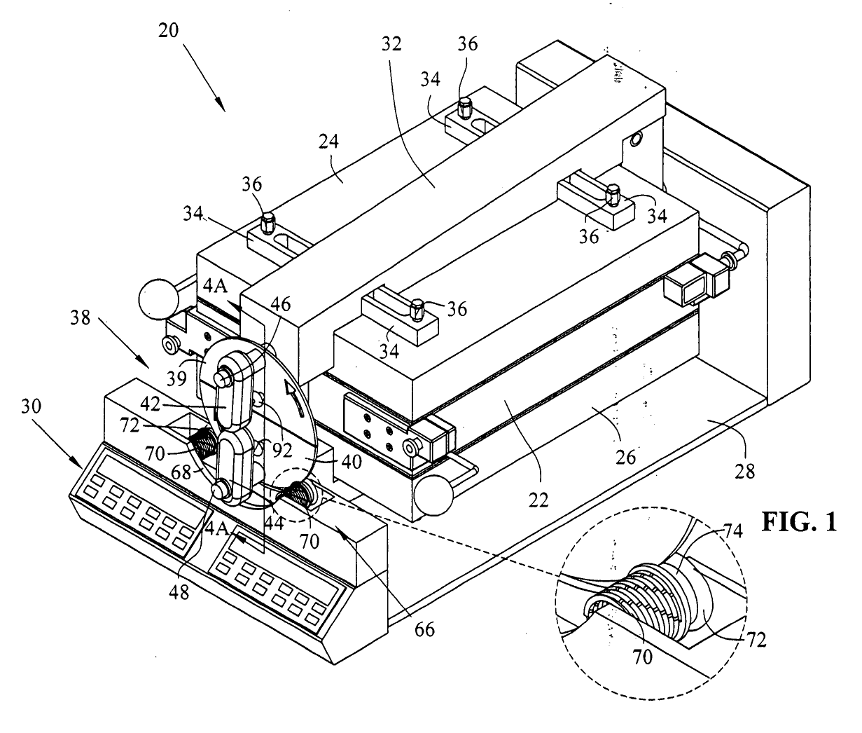

Referring first to FIG. 1, a dual level waffle iron generally indicated by numeral 20 is depicted. Dual level waffle iron 20 comprises central waffle iron section 22, first cover 24, second cover 26, base 28, and an electronic assembly generally indicated by numeral 30. It should be noted that first cover 24 and second cover 26 are substantially identical, with each having substantially identical components assembled in substantially identical manners. First cover 24 and second cover 26 are, however, located opposite each other relative to central waffle iron section 22 and are electronically linked to separate portions of electronic assembly 30, as will be described below. Therefore, unless indicated otherwise, any reference to either the components, the assembly, or the function of first cover 24 should be known to apply to second cover 26.

Referring still to FIG. 1, a hinge cover 32 extends from the front to the rear of first cover 24 through the center. Hinge cover 32 conceals a hinging channel (not shown) from which a plurality of brace members 34 extend perpendicularly outward. Each brace member 34 includes an adjustment mechanism 36 which is generally located proximate the end of the brace member 34.

Referring still to FIG. 1, a handle assembly is generally indicated by numeral 38. Handle assembly 38 includes first handle plate 39, second handle plate 40, first handle 42, and second handle 44. First handle plate 39 is located proximate first cover 24 and second handle plate 40 is located proximate second cover 26. Each handle plate 39, 40 may be manufactured from aluminum, stainless steel, or any other material which resists corrosion and has sufficient strength to support first handle 42 and second handle 44. Furthermore, each handle plate 39, 40 may include a symbol, color, or other means of differentiating first handle plate 39 from second handle plate 40. In addition, the control panels of the electronic assembly 30 may also include a similar means of differentiating thereby allowing an operator to easily distinguish which control panel corresponds to which handle plate 39, 40.

First handle 42 and second handle 44 may be manufactured from any poor thermally conductive material well known and may be attached to the handle plates 39, 40 via any known means. In addition to being thermally insulative, the material selected for the handles 42, 44 should be capable of resisting corrosion and supporting the cover members 24, 26 respectively. Furthermore, handles 42, 44 may also include a means of indicating to the operator which handle 42, 44 corresponds to which of the control panels of electronic assembly 30. Moreover, first handle 42 has a first light 46 extending therefrom, and similarly, second handle 44 has a second light 48 extending therefrom. Lights 46, 48 also represent a means of differentiating first cover 24 from second cover 26 during cooking and may be of different colors or hues.

First handle plate 39 and second handle plate 40 engage roller assembly 66, which includes U-channel 68, a pair of springs 70, a pair of grooved rollers 72, and smooth pins (not shown) which retain springs 70 in place. U-channel 68 includes an opening of sufficient size so as to allow insertion of the grooved rollers 72 and further to allow a slight forward and backward movement of the grooved rollers 72 therein. Grooved rollers 72 include a central bore (not shown) extending through the center of the grooved roller 72 and a groove 74 extending along the circumference of grooved roller 72. Grooves 74 have a width slightly larger than the thickness of first handle plate 39 and second handle plate 40. The central bore (not shown) of grooved rollers 72 should have a size approximately equal to the smooth pin, allowing insertion of the smooth pin into the grooved rollers 72 and rotation of the grooved rollers 72 around the pin.

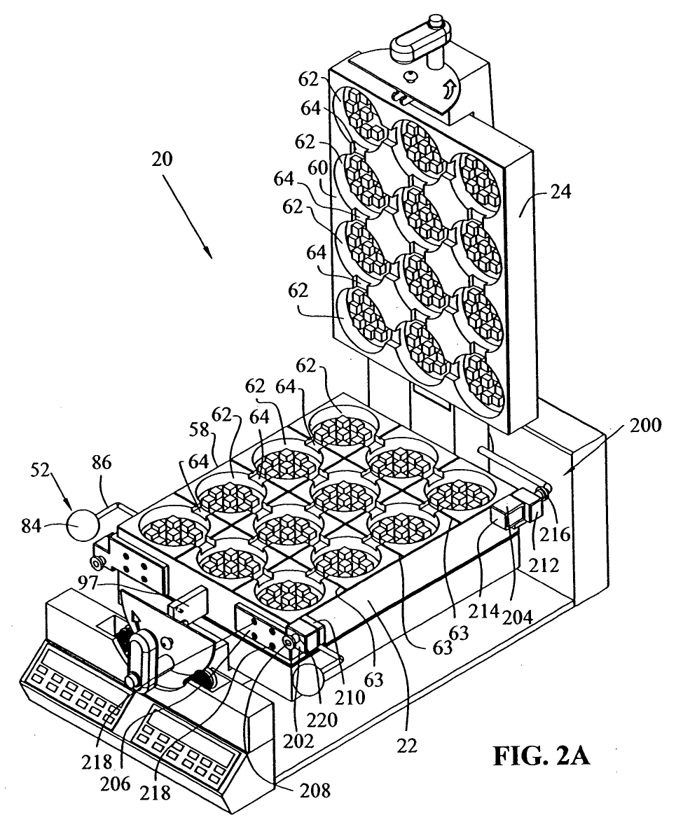

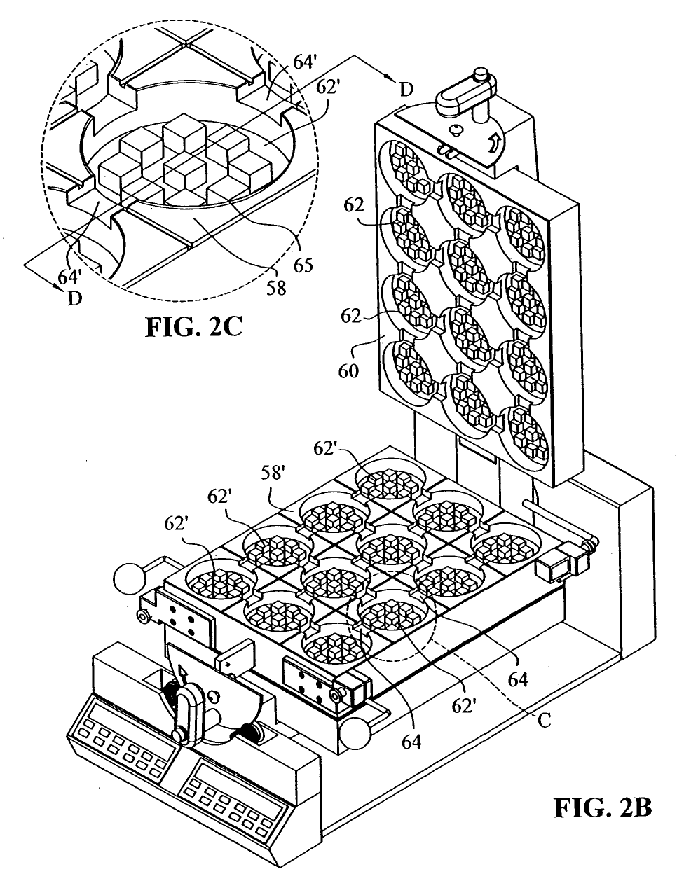

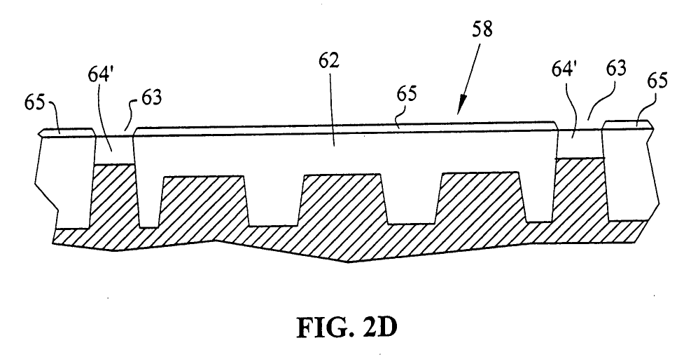

Referring now to FIG. 2A, dual level waffle iron 20 is depicted with first cover 24 in the open position. In this view, it can be seen that central waffle iron section 22 includes a first grid array 58, and first cover 24 includes a second grid array 60. First grid array 58 and second grid array 60 may be cast from any material capable of conducting sufficient heat to cook waffles, such as aluminum or stainless steel and may be coated in Teflon or similar type non-sticking material. As can be seen, first grid array 58 and second grid array 60 each has substantially similar configurations, with both including a plurality of cavities 62 and a plurality of channels 64, with the channels 64 connecting adjacent cavities 62. The cavities 62 are depicted as having a circular shape mirroring that of traditional waffles. It should be known, however, that the cavities 62 may take any desired shape.

One difference between first grid array 58 and second grid array 60 is the inclusion of a plurality of grooves 63 present in the upper face of the first grid array 58. The grooves 63 bisect the channels 64 along the longitudinal axis (not shown) of the channels 64 by crossing first grid array 58 and separating each of the cavities 62 from one another. Second grid array 60 differs from this configuration in that grooves 63 are not present, giving second grid array 60, excluding the cavities 62 and the channels 64, a substantially smooth surface.

An alternative grid array 58′ is depicted in FIGS. 2B, 2C, and 2D. Grid array 58′ includes lips 65 surrounding cavities 62′ and channels 64′. FIG. 2C depicts a blown up view of the cavity 62′ encompassed by circle “C” (FIG. 2B). FIG. 2D depicts the section view taken along line “D” depicted in FIG. 2C. As seen in all three Figures, lips 65 extend upwardly from first grid array 58′ forming a perimeter around cavities 62′ and channels 64′. As would be apparent to one having ordinary skill in the art, inclusion of lips 65 in first grid array 58′ requires second grid array 60′ to be altered in order to accept lips 65 therein, for the grid arrays 58′, 60 to be properly closed together. Therefore the cavities 62′ and channels 64′ found in second grid array 60 are made slightly larger to allow insertion of the lips 65 added to first grid array 58′.

Referring again to FIG. 2A, first grid array 58 includes a first grid hinge assembly generally indicated by numeral 200, which is located along one of the side edges. First grid hinge assembly 200 includes a forward hinge assembly 202 and a rearward hinge assembly 204. Forward hinge assembly 202 includes forward mounting bracket 206, bearing shaft 208, and casting extension 210. Likewise, rearward hinge assembly 204 includes rearward mounting bracket 212, electrical box 214, and rear bearing shaft 216.

Forward mounting bracket 206 includes a plurality of mounting apertures (not shown) of sufficient size to allow insertion of a known mounting means therein, such as screws 218, and a bearing aperture 220 of sufficient size to allow insertion of bearing shaft 208 therein. Likewise, casting extension 210 is coupled to first grid array 58 and further includes a bore (not shown) of sufficient size to also allow the insertion therein of bearing shaft 208.

Rearward hinge assembly 204 is arranged similar to forward hinge assembly 202, with rearward mounting bracket 212 including a bearing aperture (not shown) of sufficient size to allow insertion of bearing shaft 216 therein. Likewise, the rearward wall of electrical box 214 includes an aperture (not shown) of sufficient size to receive a portion of bearing shaft 216, and further is coupled to first grid array 58. Additionally, rearward mounting bracket 212 also includes a plurality of mounting apertures (not shown) similar to the apertures present within forward mounting bracket 206, with one aperture being located along the side wall of central waffle iron section 22 and a plurality of apertures being located proximate the rear wall of central waffle iron section 22 such that a screw (not shown) or similar affixing means may be inserted therein affixing the rearward mounting bracket 212 to central waffle iron section 22.

Due to the presence of a bore (not shown) in bearing shaft 216, electronic circuitry (not shown) may travel through bearing shaft 216 and be connected to the electronics of electrical box 214 in any well known manner. Furthermore, as will be explained in greater detail below, bearing shaft 216 does not rotate during the utilization of the hinge, thereby preventing movement and extending the useful life of the electronic circuitry.

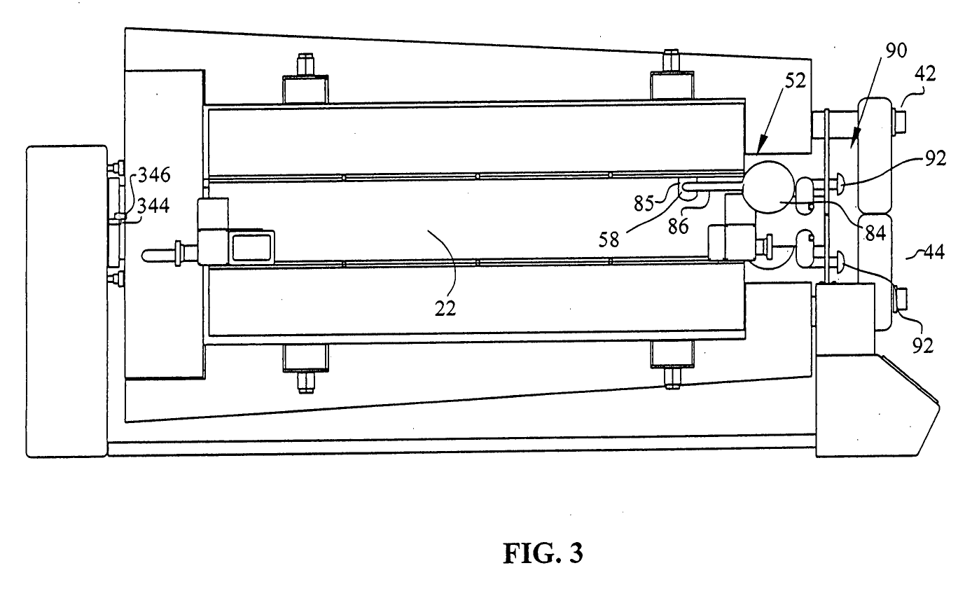

Referring now to FIG. 2A and FIG. 3, a first knob assembly 52 is located on first grid array 58 opposite first grid hinge assembly 200. First knob assembly 52 includes knob 84 and rod 86. Knob 84 may be manufactured from any thermally insulating material allowing the operator to grasp knob 84 even if rod 86 reaches an extremely high temperature. Conversely, rod 86 may be manufactured from any material capable of supporting first grid array 58 as it pivots about first grid hinge assembly 200. The end of rod 86 opposite the end to which knob 84 is attached includes threads (not shown) similar to those present on a standard machine screw. Additionally, grid array 58 includes a bore (not shown) having threads which mate to the threads of rod 86 facilitating insertion of rod 86 therein. Central waffle iron section 22 is also cut away proximate the threaded bore as is indicated by numeral 85 allowing rod 86 to be threaded into the side of first grid array 58 and extend perpendicularly therefrom.

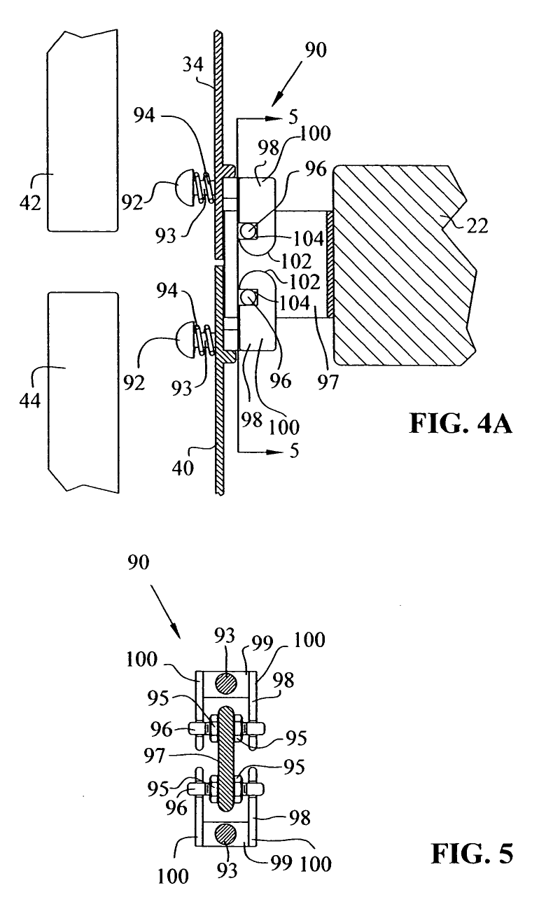

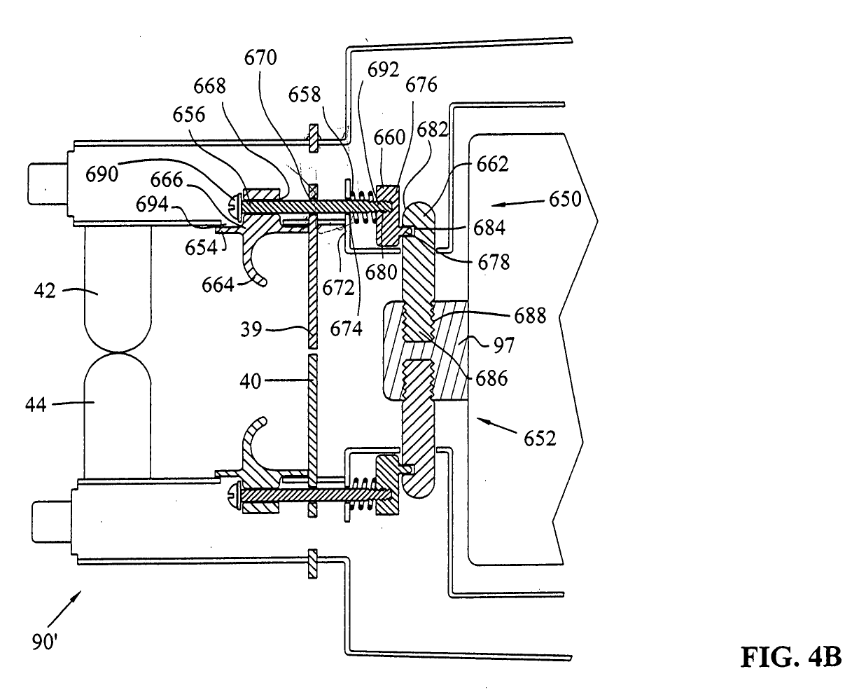

Referring now to FIG. 3, latch assembly 90 is positioned behind handles 42, 44 and includes spring loaded buttons 92. As shown in FIGS. 4A and 5, latch assembly 90 includes a pair of buttons 92, a pair of attachment rods 93, a pair of springs 94, a pair of pins 96, mounting bracket 97, and latching members 98. As shown in FIG. 4, bracket 97 extends forward from central waffle iron section 22. Buttons 92 may be any type well known with each affixed to the end of an attachment rod 93. The rods 93 have a diameter smaller than that of button 92 and spring 94 with button 92 and spring 94 having approximately equivalent diameters. This allows the rear of button 92 to function as a spring land retaining spring 94 between button 92 and one of first handle plate 39 or second handle plate 40.

Mounting bracket 97 may be affixed to central waffle iron section 22 in any well known manner and includes two apertures (not shown) through which pins 96 extend. Pins 96 may include a threaded center portion allowing the pins 96 to be secured to mounting bracket 97 by nuts 95 as shown. However, as should be apparent, the pins 96 may be retained within mounting bracket 97 via any one of a plurality of methods, including welding.

Each latching member 98 includes main body 99 and a pair of side bodies 100, which are attached thereto. Main body 99 includes a bore (not shown) into which rod 93 is secured. A side body 100 is attached to opposing sides of main body 99 with the side bodies 100 extending toward pins 96. Assembly of latch assembly 90 is as follows: Connecting rod 96 extends through first handle plate 39 and connects button 92 to notched member 98. Located between first handle plate 39 and button 92 is spring 94 which provides a force against button 92, moving it away from first handle plate 39. As button 92 is attached to connecting rod 93, the force provided by spring 94 moves notched member 98 toward first handle plate 39. Side bodies 100 each include arcuate portion 102 and notch 104, with notch 104 being of sufficient size to receive pin 96.

Referring now to FIG. 4B, an alternative embodiment of a latching assembly generally indicated by numeral 90′ is depicted. Latching assembly 90′ includes a first sub-assembly 650 and a second sub-assembly 652. The sub-assemblies 650, 652 are identical mirror images of each other. Therefore, for the sake of brevity, the components comprising the first sub-assembly 650 and the assembly thereof will be described herein, which should be sufficient to one skilled in the art to understand the assembly and function of second sub-assembly 652. As should be apparent to one with ordinary skill in the art, any references to first handle plate 39 and first handle 42 in the description of first sub-assembly 650 would be replaced with second handle plate 40 and second handle 44, respectively, while considering the assembly of second sub-assembly 652.

First sub-assembly 650 includes trigger 654, rod 656, spring 658, latching member 660, and latching post 662. Trigger 654 includes extension 664, main body 666, and bore 668. In this embodiment, extension 664 has an arcuate shape curved open toward the first handle plate 39. In alternative embodiments, however, extension 664 may be relatively straight or, if desired, may take more or less of an arc. Furthermore, Extension 664 extends downward from main body 666. In addition, main body 666 includes bore 668 which extends completely through main body 666 opening on both sides.

The rod 656 present within first sub-assembly 650 may take any one of a variety of embodiments. In the embodiment depicted, rod 656 is a standard screw having a head 690 located at one end and threads 692 located opposite thereof. Head 690 is slightly larger than the remaining portion of rod 656, and generally, includes a means of rotating the rod 656. In the embodiment depicted, head 690 includes a slot of the type well known for allowing rotation of the rod 656 with a flat head screw driver, or the like (not shown). However, in alternative embodiments, head 690 may include an “x” of the type commonly known to engage a Philips head screwdriver or, conversely, a hexagonal recess allowing a hexagonal driver to engage and rotate head 690. Generally, head 690 has a larger diameter than bore 668 whereas the remaining portion of the rod 656 has a diameter slightly less than that of bore 668.

In this embodiment, spring 658 is manufactured from stainless steel. However, in alternative embodiments, spring 658 may be manufactured from any known material having similar properties. In this embodiment, spring 658 has an inner diameter that is greater than the diameter of rod 656 thereby allowing rod 656 to extend through the center of spring 658. Furthermore, if necessary, the ends of spring 658 may be ground.

Referring still to FIG. 4B, it can be seen that latching member 660 includes main body 676 and latching extension 678. In the embodiment depicted, main body 676 is larger than latching extension 678 and includes threaded portion 680 therein. Threaded portion 680 mates with threads 692 of rod 656 and is located in main body 676 opposite latching extension 678. The latching extension 678 extends outward from main body 676 and is manufactured of the same material. However, in alternative embodiments, latching extension 678 may comprise a pin or similar extension affixed to main body 676 and manufactured from a material different than that comprising main body 676. Furthermore, latching extension 678 generally comprises an arcuate shape at the end opposite main body 676 although, in alternative embodiments, the end of latching extension 678 may be flat.

Referring still to FIG. 4B, latching post 662 is elongated and includes notch 684 and threaded portion 686. Threaded portion 686 is located at one end of the latching post with the opposite end having an arcuate surface 682. The threads comprising threaded portion 686 are sized to mate with the threaded hole 688 located within mounting bracket 97. Furthermore, notch 684 is sized to allow receipt of latching extension 678 and is located between threaded portion 686 and arcuate surface 682.

Referring still to FIG. 4B, the assembly of first sub-assembly 650 will be described in detail. Firstly, trigger 654 is inserted into slot 694 of first handle 42. Slot 694 is sized relative to trigger 654 allowing movement of trigger 654 in a direction parallel to the longitudinal axis of the waffle iron 20. Next, latching post 662 is inserted into mounting bracket 97 with threaded portion 686 being threaded into threaded hole 688. Rod 656 is then inserted into bore 668, opening 670, and opening 674. Spring 658 is then slipped onto rod 656 with rod 656 extending through the center of spring 658. Following the insertion of rod 656 through spring 658, rod 656 is then rotated and inserted into latching member 660 with the threads 692 engaging threaded portion 680 thereof. Once rod 656 is inserted into latching member 660, spring 658 should provide a spring force sufficient to drive the latching extension 678 into notch 684 of latching post 662.

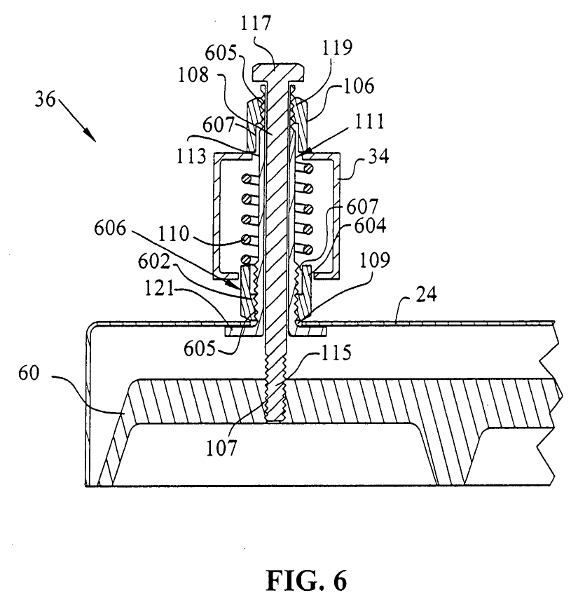

Referring now to FIG. 6, a section view of the adjustment mechanism 36 is depicted. The adjustment mechanism 36 includes a first nut cup 106, a bolt 108, a spring 110, a sleeve 113, and a second nut cup 604. The first nut cup 106 and the second nut cup 604 have identical designs in this embodiment and differ only in size and relative location of each nut cop 106, 604 in the mechanism 36. The nut cups 106, 604 include a threaded portion 605 that mates with standard threads and a smooth portion 607 which is wider than the threaded portion 605. Due to the larger diameter, the smooth portion 607 does not contact the threads 119, 602 engaging the nut cups 106, 604, respectively. Furthermore, although nut cups 106, 604 are depicted in this embodiment, it should be noted that in alternative embodiments, the nut cups 106, 604 may be replaced by standard nuts.

Referring still to FIG. 6, the bolt 108 includes a head 117 located at one end and threads 115 located opposite thereof. In this embodiment, the head 117 is hexagonally shaped and slightly larger than the remainder of the bolt 108. It should be noted, however, that the head 117 may be of any known configuration allowing the bolt 108 to be rotated in a manner well known. For example, the head 117 may be configured to receive a flat-head or Philips-head screwdriver. Furthermore, the threads 115 are sized to allow the bolt 108 to engage the threads of a threaded hole 107 located within second grid array 60.

Referring still to FIG. 6, the sleeve 113 includes a first threaded portion 119, a second threaded portion 602, and a flange 121. In this embodiment, the sleeve 113 is generally comprised of stainless steel and includes a longitudinal bore extending therethrough. The first threaded portion 119 is located at one end of the sleeve 113 with the flange 121 located opposite thereof. The flange 121 represents a flared out, flat portion of the sleeve 113 having a diameter greater than the remainder of the sleeve 113. The second threaded portion 602 is located on the sleeve 113 between the first threaded portion 119 and the flange 121. In the embodiment depicted, the second threaded portion 602 is located proximate the flange 121, although the location may be changed as necessary in the application. In addition, it should be noted that the first threaded portion 119 comprises internal threads while the second threaded portion 602 comprises external threads.

The assembly of the adjustment mechanism 36 is accomplished as follows. Firstly, the sleeve 113 is inserted into an aperture 109 located in first cover 24 from the underside, with a majority of the sleeve 113 being located above the first cover 24 and the flange 121 being located proximate the underside of the first cover 24. The flange 121 is then affixed thereto in any known manner, such as welding.

Next, the second nut cup 604 is threaded onto the second threaded portion 602 of the sleeve 113. Second nut cup 604 can slide over first threaded portion 119 to accomplish this as second nut cup 604 is sized to engage the external threads of second threaded portion 602. After threading second nut cup 604 onto second threaded portion 602, the spring 110 is then placed onto the sleeve 113 with the sleeve 113 extending though the center of the spring 110 allowing the second nut cup 604 to function as a spring land. The sleeve 113 and spring 110 are then inserted into a lower aperture 606 located within the brace member 34 with the sleeve 113 also extending through the upper aperture 111. The upper aperture 111 and the lower aperture 606 differ in size, with the upper aperture 111 having a diameter less than that of the lower aperture 606. Due to this difference in diameter, the upper aperture 111 functions as a spring land for spring 110 whereas spring 110, freely passes through the lower aperture 606.

Continuing with the description of the assembly, the first nut cup 106 is then threaded onto the first threaded portion 119 of the sleeve 113 as the threaded portion extends through the upper aperture 111. This retaining sleeve 113 in a set position relative to the brace member 34. Finally, the bolt 108 is then inserted into the center of the sleeve 113 with the threads 115 being threaded into the threaded hole 107 located in the second grid array 60. This insertion of the bolt 108 into the second grid array 60 couples the second grid array 60 to the adjustment mechanism 36.

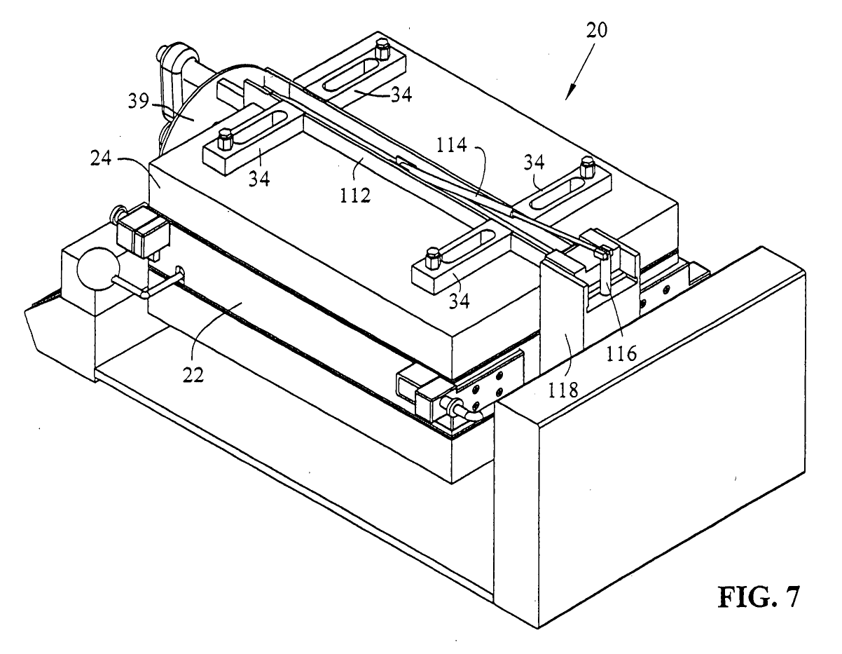

Referring now to FIG. 7, a perspective rear view of dual level waffle iron 20 is depicted. In this view, the hinge cover (referenced by numeral 32 in FIG. 1) has been removed. As can be seen, main frame member 112 extends from the rear to the front of waffle iron 20 proximate the top plain of first cover 24. A plurality of brace members 34 extend perpendicularly outward from main frame member 112 toward the side edges of first member cover 24. The rear portion of main frame member 112, opposite that proximate first handle plate 39, is coupled to yoke 118 by way of hinge means 120. Hinge means 120 may be of any type well known capable of allowing main frame member 112 to rotate upward from central waffle iron section 22. Waffle iron 20 also includes vertical rod 116 which extends vertically upward from yoke 118 and is coupled to an air spring 114 in such a manner which allows rotation of air spring 114 about the connection point between vertical rod 116 and air spring 114. Air spring 114 may be of any well known type with the first end being affixed to vertical rod 116, as stated previous, and the second end being affixed to main frame member 112.

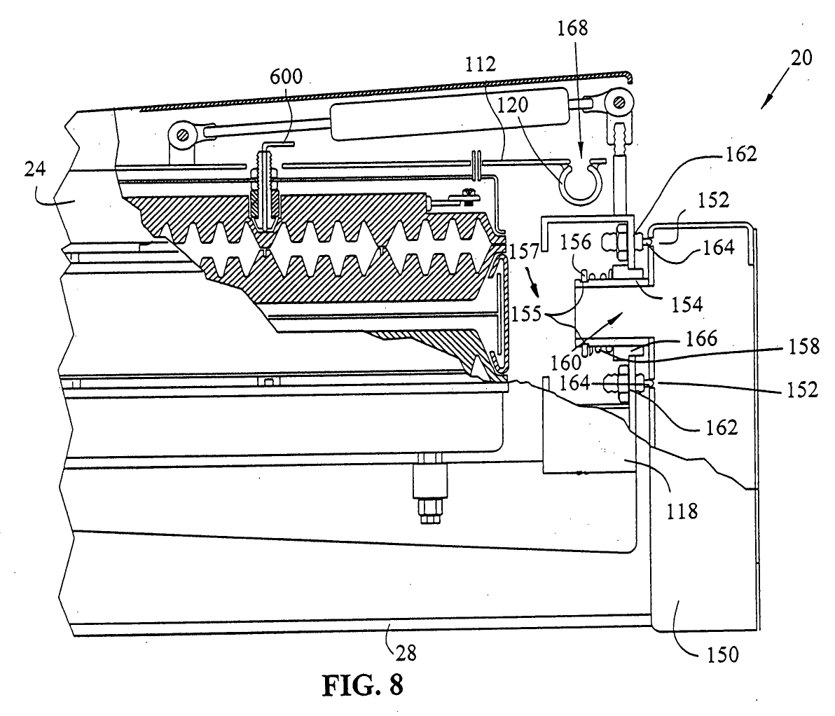

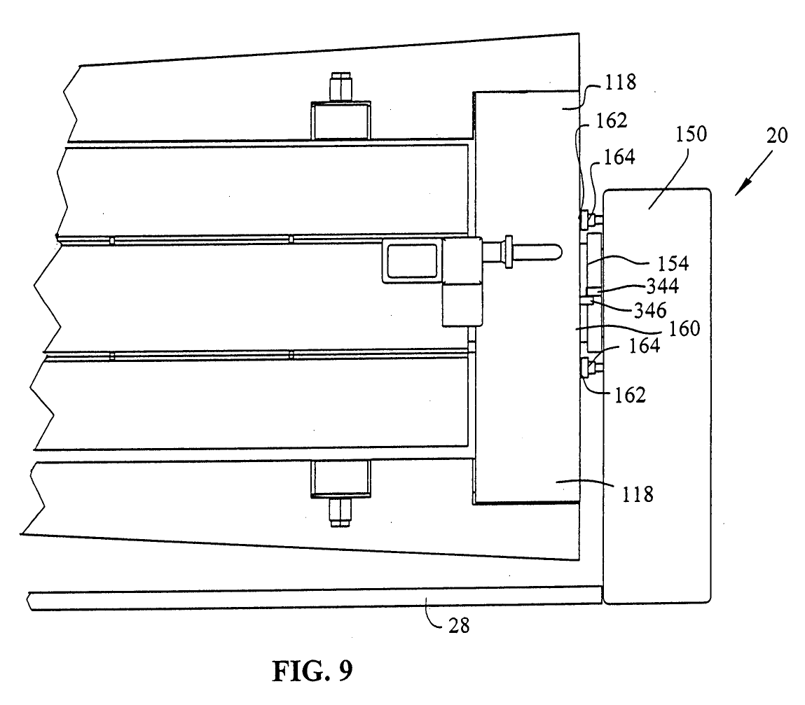

Referring now to FIGS. 8 and 9, side views of the rear of dual level waffle iron 20 is depicted. In this view, it can be seen that base 28 includes a rear portion 150, having a plurality of apertures 152, and perpendicular bearing 154. Perpendicular bearing 154 represents a rigid component affixed to rear portion 150 and extends parallel to the longitudinal axis (not shown) of waffle iron 20. Furthermore, perpendicular bearing 154 includes a notch 155 located therein. A retaining ring 156 is pressed onto perpendicular bearing 154 and located and retained within notch 155. Furthermore, in additional embodiments, the retaining ring 156 may be further affixed to the perpendicular bearing 154 by way of any well known means such as welding of brazing. In addition, the retaining ring 156 is of a size sufficient to provide a land against which spring 158 may sit squarely.

Referring still to FIGS. 8 and 9, it can be seen that yoke 118 includes rear bore 160 and a plurality of apertures 162 through which an equal number of locating pins 164 extend. The yoke 118 further includes an opening 157 located opposite the apertures 162. The opening 157 is of a size sufficient to allow the insertion of retaining ring 156 therethrough. Spring land 166 is press-fit into rear bore 160, and perpendicular bearing 154 is press-fit into spring land 166. However, in alternative embodiments, the spring land 166 may be retained to the yoke 118 by way of a plurality of fasteners. The retaining ring 156 is seated at the front end of spring land 154, and spring 158 is spring loaded between the retaining ring 156 and spring land 166. This assembly normally biases pins 164 into corresponding apertures 152.

As mentioned above, one locating pin 164 extends through each of the apertures 162 present within yoke 118. The locating pins 164 may be affixed to yoke 118 via any manner well known, such that the relative distance that locating pins 164 extend through aperture 162 remains constant relative to yoke 118. In addition, the locating pins 164 may have a hexagonal shape allowing the pins 164 to be rotated with a wrench (not shown), thereby adjusting the distance from the pin 164 to the base 150.

Referring now to FIGS. 7 and 8, it can be seen that hinge means 120 is welded to a portion of frame member 112 and further, that hinge means 120 includes slot 168. Slot 168 represents an opening through which electronic wiring (not shown) may be inserted allowing the wiring exit first cover member 24 and extend into base 150. The wiring may be fed into yoke 118 and then travel through the center of rear bearing 154 into base 150. As hinge means 120 is affixed to frame member 112, slot 168 will always be opened toward frame member 112 so as to not pinch the wiring extending therethrough upon the opening of first cover member 24. In addition, a cover (not shown) may be attached to the sides of the yoke 118 to conceal the wiring extending through the hinge means 120.

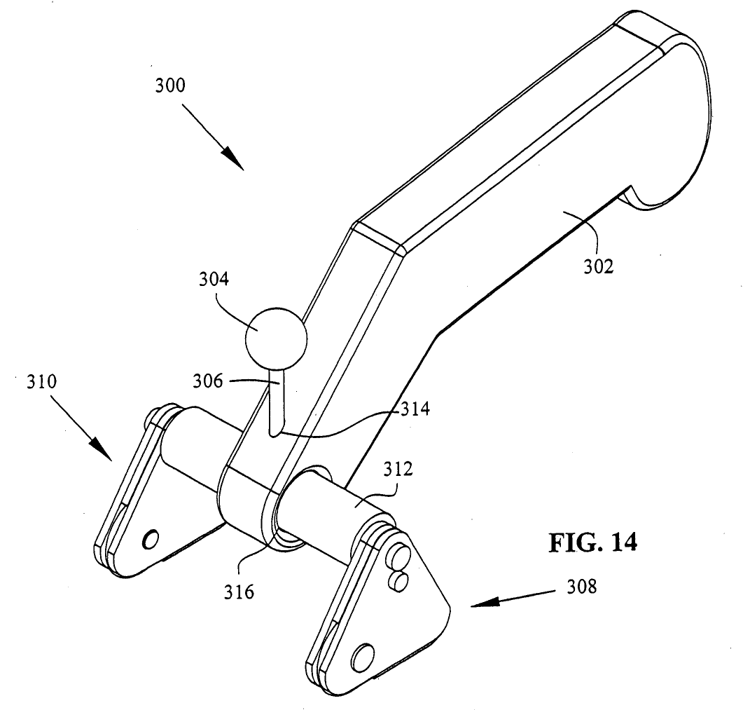

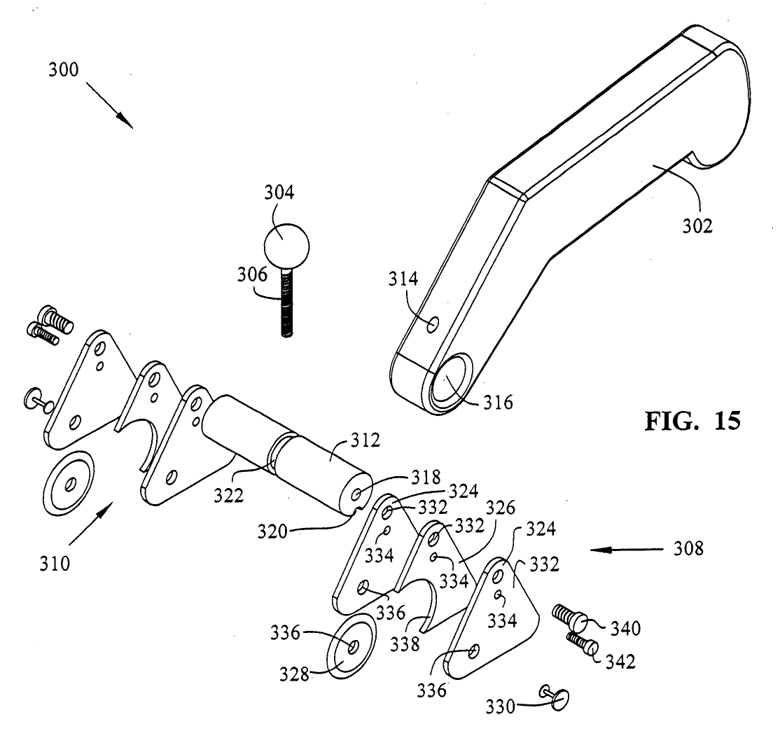

Referring now to FIGS. 14 and 15, a cutting tool generally indicated by numeral 300 is depicted. Cutting tool 300 includes handle 302, knob 304, threaded member 306, first cutting assembly 308, second cutting assembly 310 and a shaft 312. Handle 302 may be manufactured from any well known durable material, such as aluminum or plastic, and includes vertical bore 314 and horizontal bore 316. Threaded member 306, upon which is affixed knob 304, extends downward through vertical bore 314, whereas shaft 312 extends through horizontal bore 316, with shaft 312 having a threaded bore 318, a notch 320, and a groove 322. Groove 322 is generally of sufficient size so as to allow insertion of threaded member 306 therein, which has the effect of substantially centering shaft 312 within handle 302, as groove 322 is generally located in the center of shaft 312. In the alternative, the handle 302, the knob 304, the shaft 312, and all or part of the components comprising the first and second cutting assemblies 308, 310 may be manufactured as a single component, molded from plastic or the like.

Referring specifically to FIG. 15, first cutting assembly 308 is depicted as comprising a pair of frame members 324, a guide 326, a cutting wheel 328, and rivet 330. Both guide 326 and each of the frame members 324 include a bolt hole 332 and a screw hole 334. In addition, frame members 324 each also include a rivet hole 336 which is identical to the aperture located at the center of cutting wheel 328. Guide 326, however, in lieu of a rivet hole, instead includes an arcuate portion 338. It should be noted that second cutting assembly 310 includes substantially the same components as first cutting assembly 308 with the assembly being accomplished through substantially the same process.

Cutting tool 300 is assembled in the following steps: First, shaft 312 is inserted through smooth bore 316 such that shaft 312 is substantially centered within handle 302. The end of threaded member 306, opposite that which is affixed to knob 304, is then inserted through top bore 314 such that the free end of threaded member 306 rests within groove 322. A bolt 340 is then inserted through the bolt holes 332 of frame members 324 and guide 326 and then inserted into the threaded bore 318 of shaft 312, thereby securing the frame members 324 and the guide 326 to shaft 312. The next step encompasses inserting index screw 342 into screw hole 334 present within frame members 324 and guide 326 such that index screw 342 comes to rest in notch 320 of shaft 312, thereby securing the frame members 324 and the guide 326 to shaft 312. Rivet 330 is then inserted into rivet holes 336 present within frame members 324 and cutting wheel 328, securing the cutting wheel 328 between frame members 324 and coming to rest proximate arcuate projection 338 of guide 326.

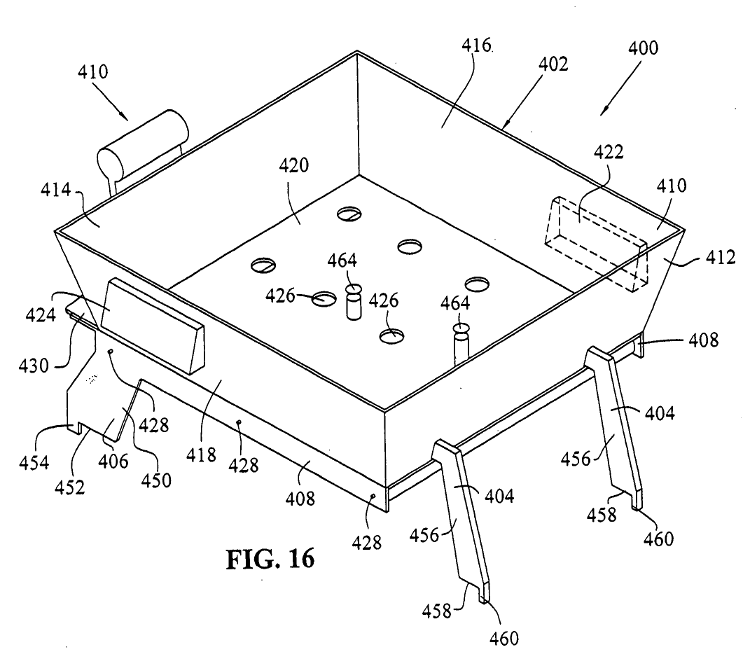

Referring now to FIG. 16, a waffle batter dispenser generally indicated by numeral 400 is depicted. Waffle batter dispenser 400 includes a dispenser bin generally indicated by numeral 402, front legs 404, rear legs 406, skirt 408, and sliding handle assembly 410.

Dispenser bin 402 includes front wall 412, rear wall 414, first wall 416, second wall 418, and floor 420, all of which may be formed from stainless steel or similar material. Front wall 412 and rear wall 414 are affixed to floor 420 at opposite edges and extend upwards therefrom. In a similar manner, first wall 416 and second wall 418 extend upwardly from the edges of floor 420 located between front wall 412 and rear wall 414. The mating edges between each of front wall 412, rear wall 414, first wall 416, and second wall 418 are substantially right angles, and it should be noted that first wall 416 and second wall 418 have a length which approximates the length of the side edges of first grid array 58 (shown in FIG. 2A or 2B). Similarly, front wall 412 and rear wall 414 have a length approximating the width first grid array 58, which gives dispenser bin 402 a shape approximating that of first grid array 58.

Dispenser bin 402 also includes a first handle 422 attached to the outer surface of first wall 416 and second handle 424 attached to the outer surface of second wall 418. The handles 422, 424 may be of any type well known and give the operator a means of transporting the waffle batter dispenser 400.

Floor 420 is substantially planar and extends horizontally in waffle batter dispenser 400. Floor 420 includes a plurality of floor apertures 426 spaced in a pattern substantially identical to the location of the center of cavities 62 (shown in FIG. 2A) present within first grid array 58. Additionally, waffle batter level indicators 464 have a milk bottle shape and are affixed to floor 420. Waffle batter level indicators 464 are manufactured from stainless steel or a similar material and are located proximate the center of floor 420 between floor apertures 426.

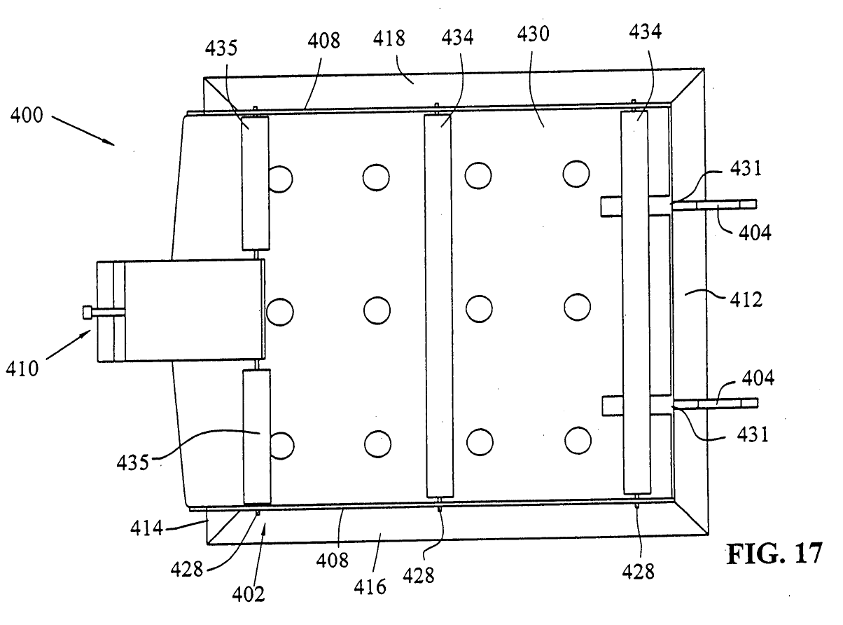

Referring now to FIGS. 16 and 17, skirts 408 are shown attached to the lower edges of first wall 416 and second wall 418 and extending downward. Three rods 428 extend across the width of batter dispenser 400 through skirts 408. The rods 428 generally are manufactured from stainless steel or similar type material. Referring now specifically to FIG. 17, it can be seen that rods 428 located nearest forward wall 412 each extend through the center of a long roller 434. Additionally, the rod 428 located nearest to rear wall 414 extends through the center of two short rollers 435, with the first short roller being located proximate left wall 416 and the second located proximate right wall 418.

Referring now to FIGS. 17, 18, and 19, plate 430 is retained between the rollers 434, 435 and the underside of floor 420. Plate 430 is substantially planar and includes a plurality of plate apertures 432 having a pattern substantially similar to the pattern of floor apertures 426 within floor 420.

Sliding handle assembly 410 is affixed to plate 430 proximate the rearward edge of plate 430 by way of any method well known, such as welding or through the utilization of standard machine screws (not shown). Sliding handle assembly 410 includes a handle portion 436, spring 438, adjustment screw 440, retaining plate 442, and main body 444. Main body 444 represents the portion of sliding handle assembly 410 affixed to plate 430 as described above. Handle portion 436 extends upwardly from the rear edge of main body 444 and may be configured in any manner well known so as to allow an operator to easily grip the handle portion 436 for sliding movement.

Furthermore, plate 430 includes a pair of notches 431 located opposite sliding handle assembly 410. The notches 431 each align with a front leg 404 and are of a sufficient width to allow the front legs 404 to be located therein.

Main body 444 includes a bore 446 into which adjustment screw 440 is threaded. Additionally, main body 444 further includes a channel 448 of sufficient size to retain spring 438 therein. Channel 448 extends into main body 444 a sufficient distance to encounter bore 446. Main body 444 further includes a pair of grooves 445 located on the opposing sides of channel 448. The grooves 445 begin proximate retaining plate 442 and run toward adjustment screw 440. In the embodiment depicted, the grooves 445 do not reach adjustment screw 440, but rather only extend to an intermediate point between retaining plate 442 and adjustment screw 440. The grooves 445 are large enough to allow rod 428 to extend therethrough without causing any type of interference contact.

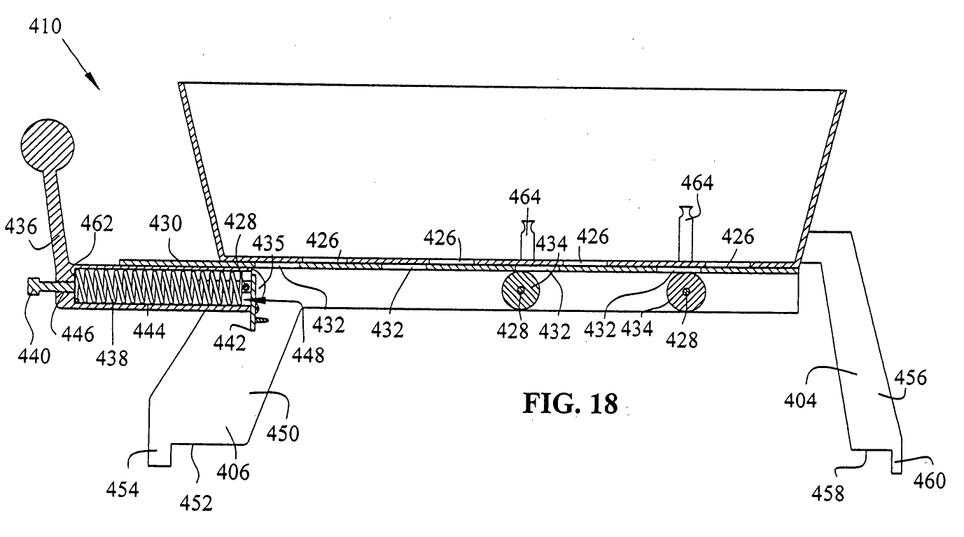

Referring again to FIGS. 16 and 18, rear legs 406 are depicted as extending downward from the rear of skirts 408 and include a body portion 450, a seating portion 452, and a catch portion 454. Rear legs 406 are generally manufactured from the same material as skirts 408. Furthermore, rear legs 406 may be formed from the same piece of material as the skirts 408 from which the rear legs 406 extend, as depicted here, or conversely, the rear legs 406 may constitute separate components attached to the skirts 408 in any well known manner. The lower edge of body portion 450, referred to as seating portion 452, is substantially horizontal and flat with catch portion 454 extending downward from the rear of seating portion 452.

Similarly, front legs 404 are affixed to front wall 412 and include a body portion 456, a seating portion 458, and catch 460. Body portion 456 may take any shape desired which is capable of supporting the waffle batter dispenser 400 while it is full of waffle batter. Additionally, body portion 456 extends substantially vertical with seat portion 458 being located along the lower edge and in the same plane as seating portion 452 of rear leg 450. The forward portion of seat portion 458 is referred to as catch 460 which extends downwardly lower than seat portion 458.

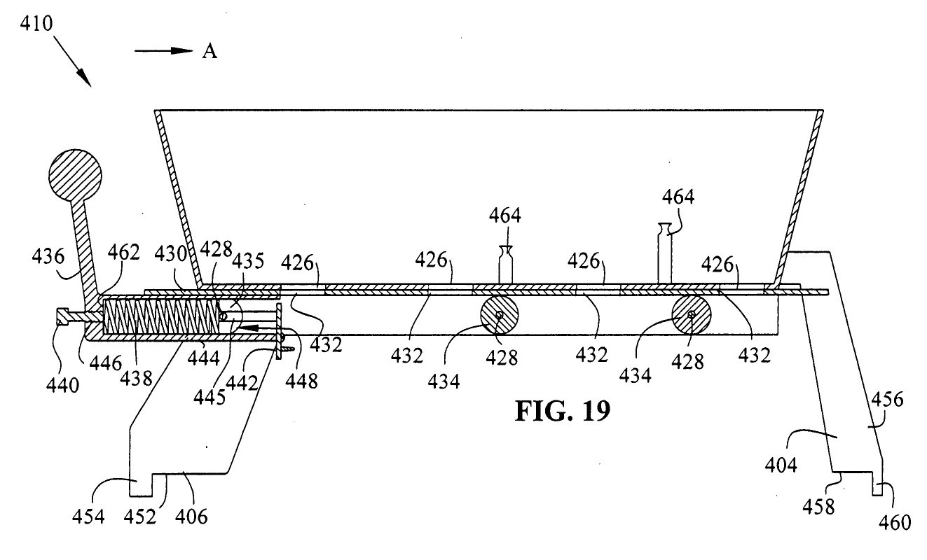

With reference to FIG. 19, final assembly of the waffle batter dispenser 400 is accomplished as follows: Spring 438 is placed within channel 448 of sliding handle assembly 410. Plate 430, with sliding handle assembly 410 attached as described above, is then inserted between the rollers 434, 435 and floor 420 with main body 444 being positioned between the two short rollers 435. Spring 448 is allowed to expand between land 462 of main body 444 and the rearward rod 428 which supports short rollers 435. The expansion of spring 448 creates a rearward force against main body 444 thereby moving main body 444 away from short rollers 435. A retaining plate 442 is then affixed, by way of any well known means, to main body 444 substantially covering channel 448. Additionally, batter level indicators 464 are attached to floor 420 in any known manner, such as welding or through the use of an adhesive.

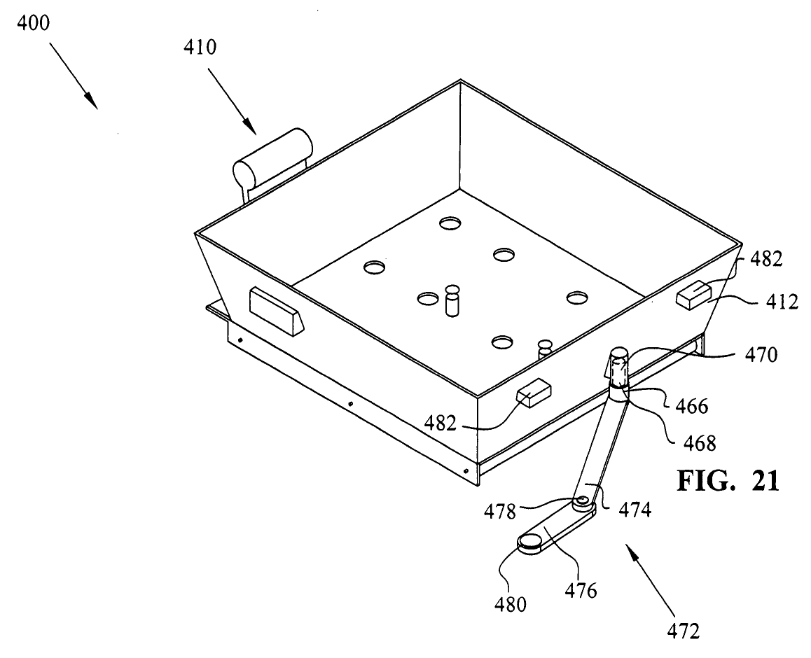

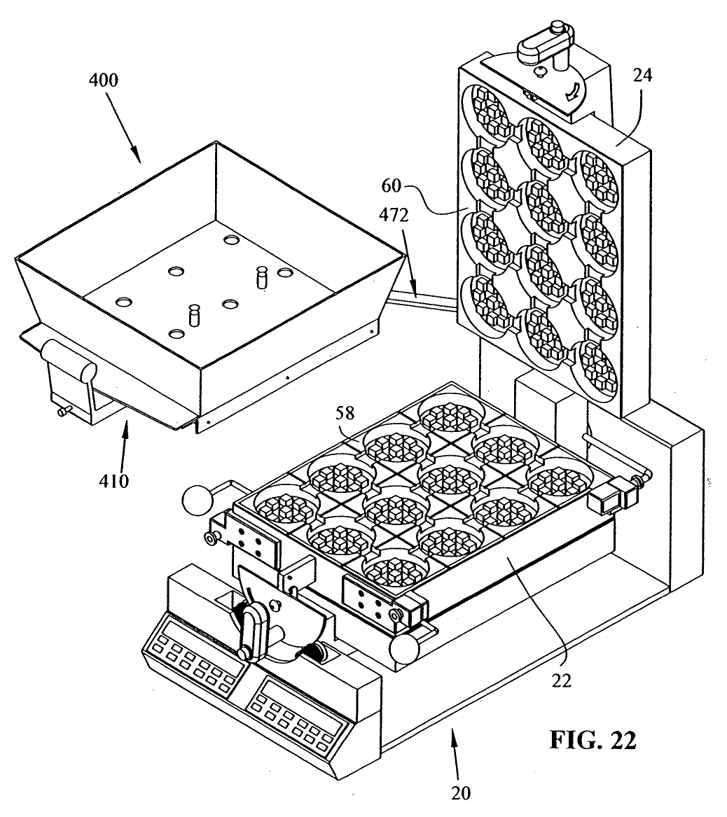

Referring now to FIGS. 21 and 22, an alternative embodiment of waffle batter dispenser 400 is depicted. This alternative embodiment does not include front legs 404 and rear legs 406 (shown in FIGS. 16-20), but rather includes a cylinder 470 attached to front wall 412. In this embodiment, the cylinder 470 includes an opening and is welded to the front wall 412 in a manner such that the opening is directed downward. Furthermore, this embodiment of the waffle batter dispenser 400 also includes an adjustment arm generally indicated by numeral 472.

Adjustment arm 472 includes first member 474 and second member 476 each comprising elongated planar plates manufactured from aluminum, stainless steel, or any similar material. First member 474 and second member 476 are joined via the insertion of a fastener 478 through apertures (not shown) located at the end of each of the members 474, 476. A nut (not shown) is then affixed to fastener 478 in a well known manner thereby retaining the members 474, 476 together. This allows the members 474, 476 to pivot relative to each other about fastener 478.

Located at the end of first member 474, opposite the end joined to second member 476 by fastener 478, is a raised cup 466 that is opened upwards. A pin 468 with a diameter slightly less than the inner diameter of cylinder 470 is located within the raised cup 466. Pin 468 extends vertically having a cylindrical shape along its entire length. In alternative embodiments, however, pin 468 may be tapered at the top as desired.

Opening 480, which is located at one end of second member 476, may be attached to a vertical rod (not shown) extending from waffle iron apparatus 20. In the alternative, the vertical rod may be separate from waffle iron 20, if so desired. Any well known means may be employed for retaining the adjustment arm 4722 at a given height relative to the vertical rod.

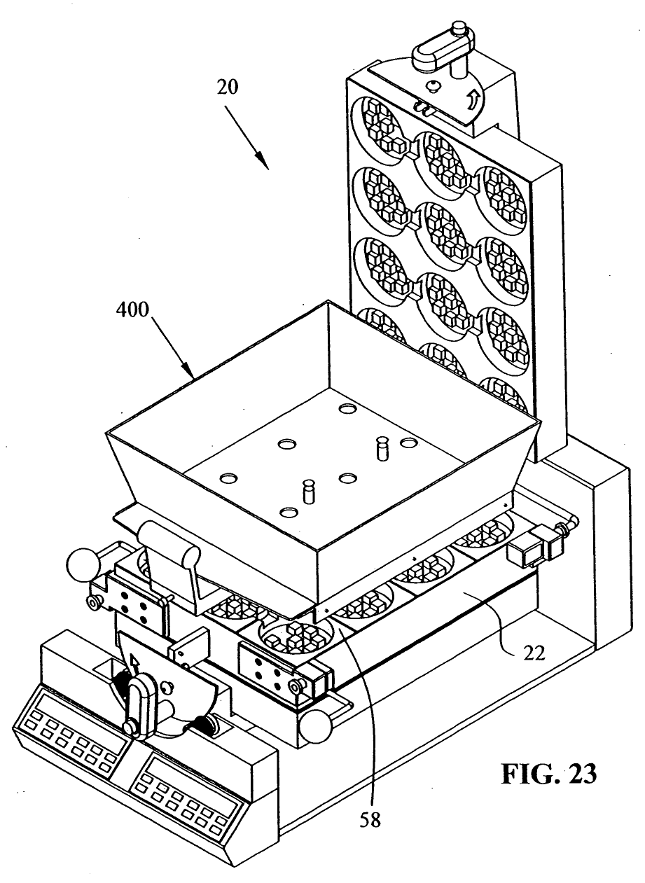

Once adjustment arm 472 is attached to the vertical rod, the waffle batter dispenser 400 may be connected thereto by slipping cylinder 470 onto the portion of pin 468 extending upwards from raised cup 466. This allows the waffle batter dispenser 400 to rotate about pin 468. Furthermore, waffle batter dispenser 400 may be removed from adjustment arm 472 without the use of tools, for cleaning or similar maintenance. Furthermore, the easy removal of the waffle batter dispenser 400 from the adjustment arm 472 allows an operator to fill the dispenser 400 with waffle batter at a location removed from the first and second grid assemblies 58, 60 (in FIG. 2) during cooking. Furthermore, as should be apparent to one having ordinary skill in the art, the combination of the rod, the adjustment arm 472, and the cylinder 470 allows waffle batter dispenser to be moved from a first position depicted in FIG. 22 to a second position over first grid array 58 depicted in FIG. 23.

The alternative embodiment of waffle dispenser 400 further includes bumpers 482 preferably manufactured from Teflon or similar type material that is a poor conductor of heat. Bumpers 482 may be attached to front wall 412 at any height, as desired, or if a lid is employed, the bumpers 482 may be attached thereto. Bumpers 482 abut against second grid array 60 as the operator (not shown) moves sliding handle assembly 410 in order to dispense the waffle batter.

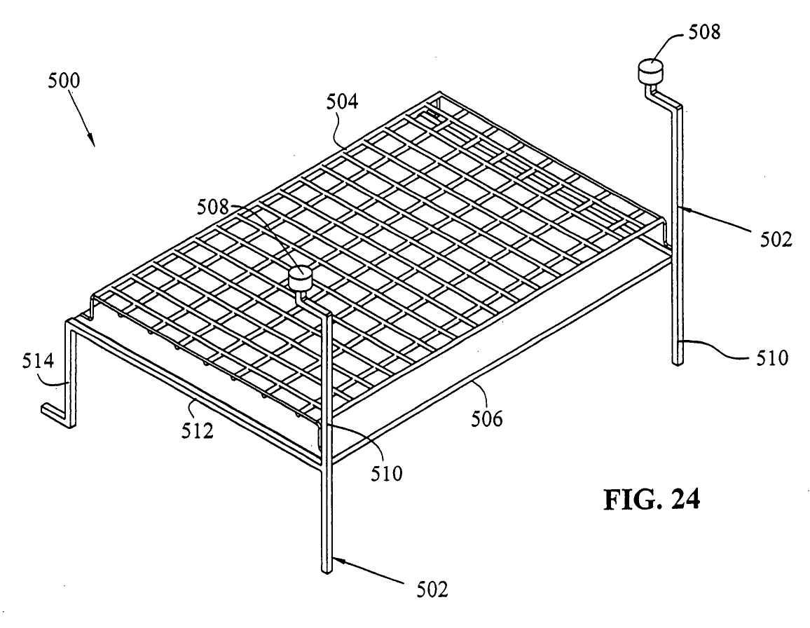

Referring now to FIG. 24, a steam pan frame is generally indicated by numeral 500. Steam pan frame 500 includes a pair of frame members 502, wire rack 504, and connecting plate 506. Frame members 502 may be manufactured of stainless steel or similar type material and with each including stop 508, vertical member 510, horizontal member 512, and front support frame 514. Vertical member 510 extends vertically with stop 508 being attached to the top end and the lower end functioning as a base for the steam pan frame 500. A horizontal member 512 extends forwardly between the two ends of frame member 502. At the forward end of horizontal member 512 is front support member 514 which functions as a front base for supporting steam pan frame 500. Front support member 514 may take any shape desired which is capable of supporting steam pan frame 500. It should be noted that frame member 502 may be comprised of individual components affixed together, or may be formed from a single piece of material as desired.

Referring still to FIG. 24, connecting pan 506 extends between the two frame members 502 and is affixed to the horizontal member 512 of each. Connecting pan 506 functions as both a brace for retaining the frame members 502 vertically and a support for wire rack 504 or a steam pan (not shown). Wire rack 504 may be of any type well known in the art for receiving waffles (not shown) cooked by the waffle iron.

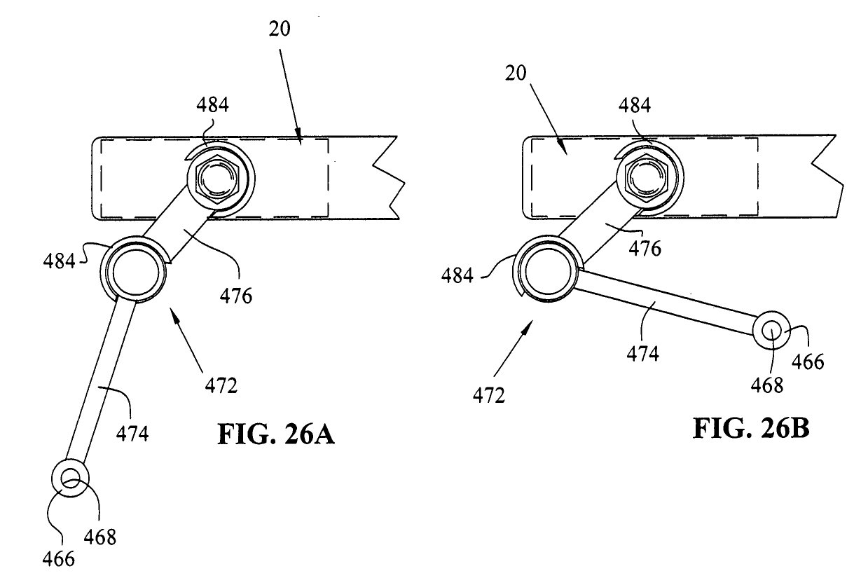

Referring now to FIGS. 26A and 26B, an alternative embodiment of adjustment arm 472 is depicted. In this embodiment, adjustment arm 472 further includes a stopping members 484 which form raised portions extending upwards from first member 474 and second member 476 at the junction between the two members 474, 476 and at the junction between the adjustment arm 472 and the waffle iron 20.

Referring again to FIGS. 1 and 2, now that the individual components of the dual level waffle iron have been described, the operation of the dual level waffle iron 20 will be explained in detail. Starting from the closed position of depicted in FIG. 1, firstly, electronic assembly 30 may be activated and set to a temperature. The electronic assembly 30 is coupled to a thermo-couple (referenced by numeral 600 in FIG. 8) for sensing the temperature of the grid arrays 58, 60 and a heating means (not shown) for heating the grid arrays 58, 60 of the waffle iron 20. The electronic assembly 30 is capable of displaying the temperature of the grid arrays 58, 60 as determined by the thermo-couple 600. Furthermore, an operator may set the desired temperature of the grid arrays 58, 60 using electronic assembly 30. As should be known to one possessing ordinary skill in the art, if needed a spring or similar device (not shown) may be utilized between a cover member 24, 26 and the thermo-couple 600 in order to ensure the thermo-couple 600 stays secured against the corresponding grid array 58, 60.

Referring now to FIGS. 2 and 4A, once the desired temperature of the grid arrays 58, 60 has been reached, the electronic assembly 30 gives a signal, audible or otherwise. The operator then depresses button 92, causing latching member 98 to move rearwardly, disengaging notch 104 from pin 96, which allows first cover 24 to be opened into the position depicted in FIG. 2A. In the alternative, referring to FIGS. 2 and 4B, first cover 24 may be moved to the open position by pulling trigger 654 toward first handle 42. Movement of the trigger 654 toward first handle 42 also moves rod 656 in the same direction. This movement, in turn, repositions latching member 660 thereby withdrawing latching extension 678 from notch 684.

Upon raising first cover 24 and exposing the previously concealed grid arrays 58, 60, the operator may pour waffle batter (not shown) into the cavities 62 of first grid array 58 in a variety of manners. For example, a pitcher (not shown) including waffle batter may used to fill each cavity 62, individually. In the alternative, the operator may choose to fill the cavities 62 by starting with a cavity 62 located in the corner of first grid 58 and following a continuous “S” shaped pattern through the pour. The operator may also utilize waffle batter dispenser 400 to add the batter to all of the cavities 62 of first grid array 58 simultaneously.

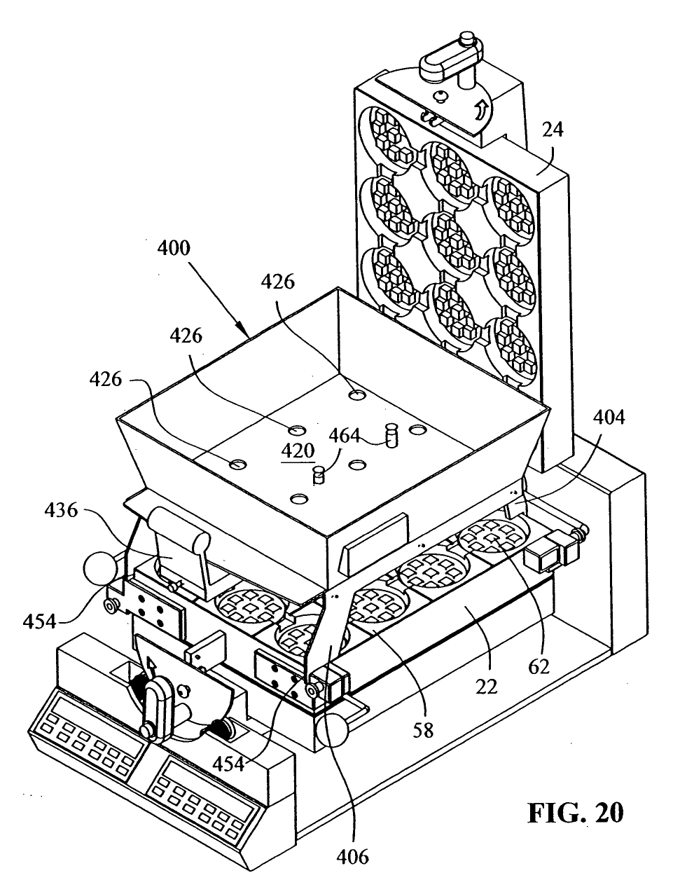

In operation, waffle batter dispenser 400 is filled with waffle batter (not shown) and placed on top of first grid array 58 as is shown in FIG. 20. Referring again to FIG. 18, when no force is placed upon handle portion 436, spring 438 acts against rear rod 428 and forces sliding handle assembly 410 rearward until retaining plate 442 contacts rear rod 428, preventing additional movement. As should be apparent, movement of sliding handle assembly 410 creates movement of plate 430 as the two components are affixed to one another. In this position, plate apertures 432 are not aligned with floor apertures 426 preventing any waffle batter from traveling through.

Referring now to FIGS. 19 and 20, a force, indicated by arrow A, has been applied to handle portion 436 by the operator (not shown) compressing spring 438. The operator is able to continuously apply a force to spring 438 until the end of grooves 445 contact rod 428 thereby preventing further movement of the sliding handle assembly 410 and the plate 430. It should be noted that the notches 431 are of sufficient size to allow the front legs 404 to be located therein without contact. Furthermore, the notches 431 prevent the front legs 404 from contacting the plate 430. When plate 430 slides into the fully open position with rod 428 contacting the end of grooves 445. When plate 430 is moved to this position plate apertures 432 become aligned with floor apertures 426 allowing the batter (not shown) present within dispensing bin 402 to travel through the aligned apertures 426, 432 and be dispensed upon the cavities 62 located within first grid array 58. Furthermore, movement of waffle batter dispenser 400 due to the force indicated by arrow A is prevented by catch portion 454 which hangs over the front of central waffle iron section 22.

Batter level indicators 464 extend a predetermined height above floor 420 for the purpose of indicating to the operator when batter dispenser 400 does not contain enough batter to properly fill the cavities 62 of first grid array 58. Therefore, during the course of producing large quantities of waffles, when waffle batter indicators 464 become viewable, an operator is informed that more waffle batter must be added to the waffle batter dispenser 400 before attempting to add waffle batter to the dual level waffle iron 20. In the alternative, the waffle batter indicators 464 may be of differing sizes, wherein one indicator 464 may indicate when less than two pours remain in the dispenser 400 and the second, smaller indicator 464 shows when only one pour remains.

The alternative embodiment of waffle batter dispenser 400 dispenses batter in a similar manner. Waffle batter dispenser 400 is located by the operator over first grid array 58 by movement of adjustment arm 472 as is shown in FIG. 22. This alternative embodiment functions exactly as described above; however, movement of the waffle batter dispenser 400 is prevented by bumpers 482 which abut against second grid array 60 as waffle batter is dispensed.

Referring now to FIGS. 26A and 26B, one can appreciate how the alternative adjustment arm 472 depicted may prevent undesirable movement of the waffle batter dispenser (not shown in these Figures). As depicted, the stopping member 484 attached to second member 476 only allows first member 474 to swing from a position directly over the grid array (not shown) as shown in FIG. 26B, to a set position wherein the waffle batter dispenser is clear of the grid array, as is shown in FIG. 26A. Further rotation in either direction is prevented by the contact between the stopping member 484 and first member 474. In this manner, the stopping members 484 indicate to an operator when the waffle batter dispenser is properly situated over the grid array or when the waffle batter dispenser is clear from the grid array.

The usage of waffle batter dispenser 400 allows large amounts of waffle batter to be evenly dispensed into grid array 58 quickly and easily. The operator may also include a lid (not shown), if desired, in order to prevent evaporation of water in the waffle batter if the production of waffles is expected to take place over an extended length of time. Furthermore, it should be noted that either dispenser may be adapted to be used with a traditional grill to dispense pancake batter or the like without departing from the spirit of the invention.

The inclusion of the channels 64 between each of the cavities 62 ensures that the operator will realize substantially equal amounts of waffle batter in the cavities 62, as excess waffle batter present in some of the cavities 62 will flow through the channels 64 into adjacent cavities 62 having less batter. Further, as channels 64 represent a means of self equalizing the amount of batter in each of the cavities 62, waste is reduced as batter in an over-filled cavity is not forced from the over-filled cavity 62 onto the surface of the grid array 58 where the batter will be wasted and dirty the grid array 58.

After adding batter to the cavities 62, the operator lowers the first cover 24 into the closed position adjacent to central waffle iron section 22. It should be noted that the presence of air spring 114 and the location of the joint between air spring 114 and vertical rod 116 (as seen in FIG. 7) relative to hinge means 120 prevents first cover 24 from rapidly descending toward central waffle iron section 22. This configuration allows first cover 24 to be lowered slowly onto central waffle iron section 22, thereby ensuring the operator will have sufficient time to move safely away from the area between the grid arrays 58, 60.

As should be appreciated by one possessing ordinary skill in the art, during the closure of first cover 24, the operator need not depress button 92 in order to facilitate the latching of latched member 98 and pin 96. Referring again to FIGS. 4A and 5, it should be understood that as first cover 24 is closed, arcuate portion 102 comes into contact with pin 96, causing rearward movement of latching member 98. When pin 96 aligns with notch 104, spring 94 causes latching member 98 to move forward securing pin 96 within notch 104 and retaining first cover 24 closed against central waffle iron section 22.

Furthermore, in the alternative embodiment of the latch assembly 90′ depicted in FIG. 4B, the contact between arcuate surface 682 of latching post 662 and latching extension 678 as the first cover 24 closes drives latching member 660 toward first handle 42. Once latching extension 678 aligns with notch 684, the spring force provided by spring 658 will move latching extension 678 into notch 684, thereby securing first cover 24 in the closed position proximate central waffle iron section 22.

Once the operator fills first grid array 58 with waffle batter and closes first cover 24, the operator starts a timer located within electronic assembly 30. The activation of the timer starts a countdown allowing the operator to more easily monitor the cooking time of the waffle batter baking between first grid array 58 and second grid array 60. In addition, first indicator light 46 illuminates in order to remind the operator that batter is cooking within that level of the waffle iron. In addition, in an alternative embodiment, first indicator light 46 may function as the switch which activates the timer. In this alternative embodiment, the operator depresses first indicator light 46 into first handle 42 starting the timer displayed in electronic assembly 30 and causing first indicator light 46 to illuminate as a reminder to the operator that waffles are cooking therein.

Referring now to FIGS. 1, 2, and 6, it should be apparent to one having ordinary skill in the art that the inclusion of a plurality of the adjustment mechanisms 36 in the dual level waffle iron 20 allows for the vertical movement of the second grid array 60 relative to both the main frame member 112 and the central waffle iron section 22, including the first grid array 58. This movement improves the cooking performed by the waffle iron, by allowing the batter to expand as it is heated during the cooking process. The hindering of the expansion of the waffle batter results in waffles having a harder and heavier consistency, which is generally undesirable. Therefore, the inclusion of the adjustment mechanisms 36 in the dual level waffle iron 20 ensures the waffles prepared therein are light and fluffy, as is generally desired. This is accomplished as the adjustment mechanism 36 allows the grid arrays 58, 60 to separate during cooking as the batter expands. In addition, the adjustment mechanism 36, depicted herein, allows an operator to adjust the tension of spring 110 in order to alter the final consistency of the cooked waffles, as desired.

In the present embodiment of the adjustment mechanism 36, the interaction between the first nut cup 106 and the first threaded portion 119 controls the minimum distance separating the first grid array 58 and the second grid array 60. This is accomplished by controlling the vertical position of the second grid array 60 relative to the top surface of the brace members 34. As the first nut cup 106 rests against the top surface of the brace member 34, the interface between the first threaded portion 119 and the first nut cup 106 determines which portion of sleeve 113 will extend downward through the brace member 34. Furthermore, as the head 117 of the bolt 108 rests upon the sleeve 113, movement of the sleeve 113 relative to the brace member 34 translates into movement of the second grid array 60 relative to the brace member 34, due to the engagement of the threads 115 and the threaded hole 107.

Moreover, in the present embodiment, the second nut cup 604 controls the tension of the spring 110. This tension is directly proportional to the final consistency of the waffles baking within the dual level waffle iron 20. The rotation of the second nut cup 604 creates movement in the nut cup 604 relative to the second threaded portion 602 of the sleeve 113. Since the spring 110 is retained between the brace member 34 and the second nut cup 604, any vertical movement of the second nut cup 604 alters the spring force exerted by the spring 110 by either expanding or compressing the spring 110. An increase in the spring force exerted by the spring 110, creates a more dense waffle, due to the greater spring force reducing the separation distance between the first grid array 58 and the second grid array 60 as the waffle batter cooks. Conversely, a reduction in the spring force allows the waffle batter to expand more easily, thereby creating lighter and fluffier waffles.

As stated above, the inclusion of an adjustment mechanism 36 allows an operator to alter the consistency of the waffles prepared with the dual level waffle iron 20 meaning that some batches of waffles may be prepared lighter than standard waffles while other batches may be prepared with a heavier consistency. Furthermore, the vertical movement achieved by the adjustment mechanism 36 allows the waffles to have a more defined, crisp shape. In addition, the adjustment mechanism 36 prevents batter from running out of the cavities 62, thereby preventing the build up of charred waffle batter on the grid arrays 58, 60. The adjustment mechanism 36 also prevents waffle batter from running down and dirtying the side of the waffle iron 20. Moreover, as should be apparent to one possessing ordinary skill in the art, the inclusion of the adjustment mechanism 36 allows for the use of a thinner batter which is likely to expand at a greater rate than thicker batter. This is desirable as the thinner batter flows more easily from the waffle batter dispensers 400, described above, than does the thicker batter.

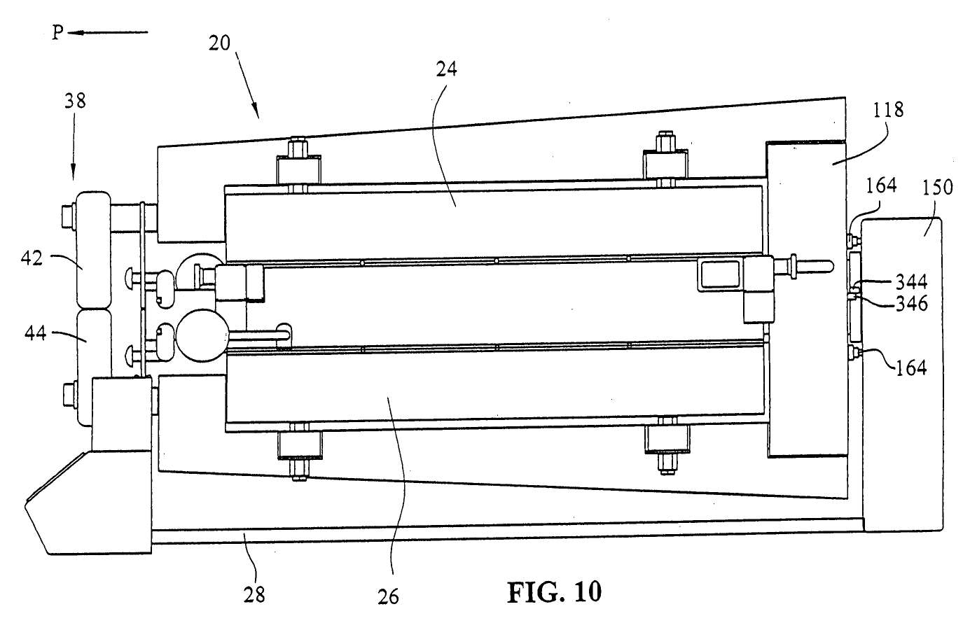

Referring now to FIG. 10, a side view of waffle iron 20 is depicted. It should be noted that pins 164 are engaged with the apertures (not shown) of rear portion 150. An operator may grip handle assembly 38 at first handle 42 and second handle 44, and pull the waffle iron 20 forward in a direction indicated by arrow “P”. It should be noted that when the cover members 24, 26 are closed, first handle 42 and second handle 44 are aligned along a longitudinal axis (not shown). Although this longitudinal axis may extend completely vertical, in the embodiment depicted herein (as shown in FIG. 1), the longitudinal axis is angled slightly in order to allow the operator an easier time of gripping the handles 42, 44 during rotation.

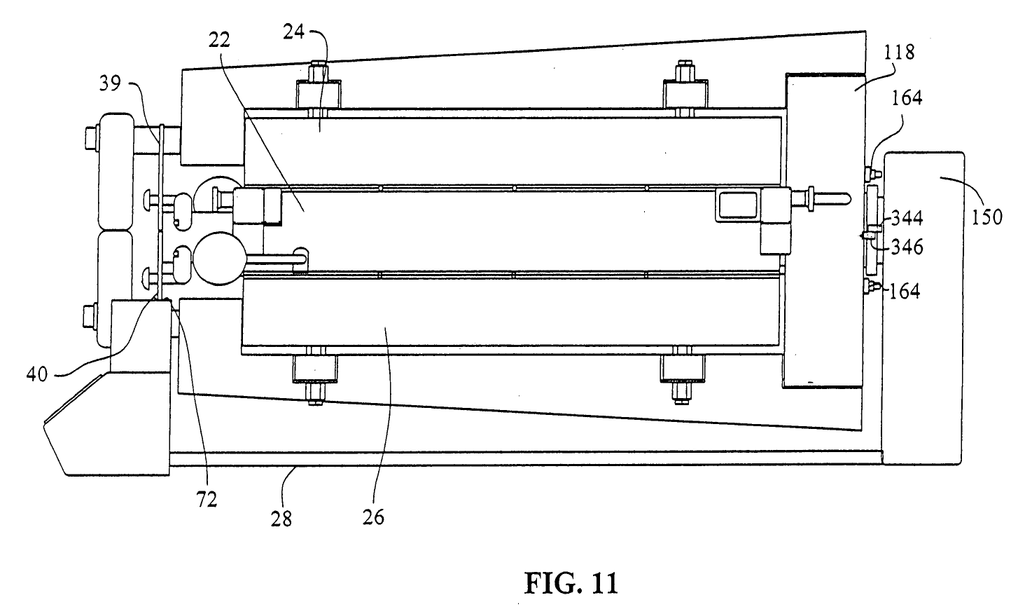

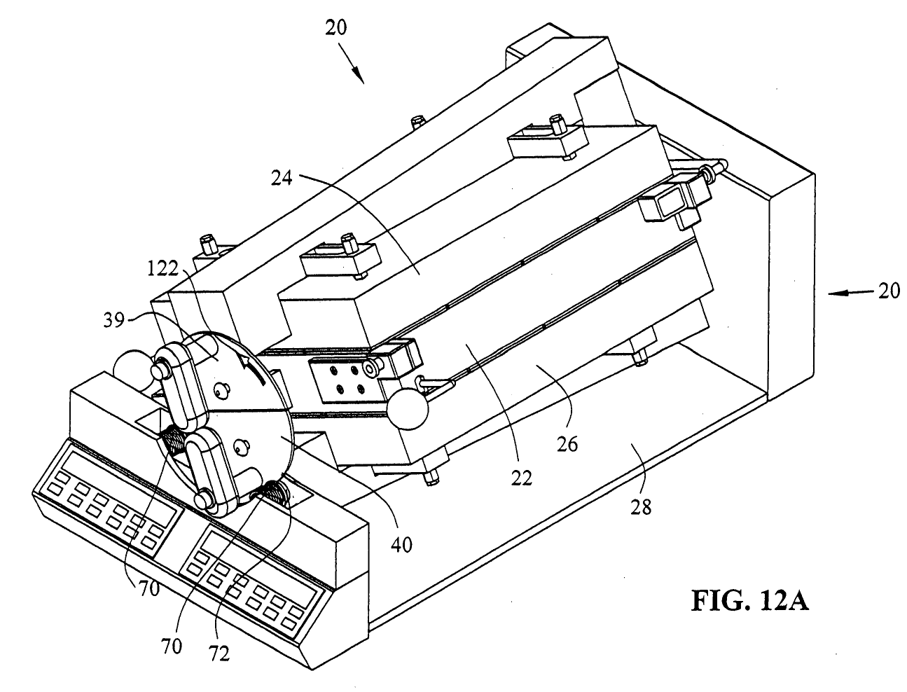

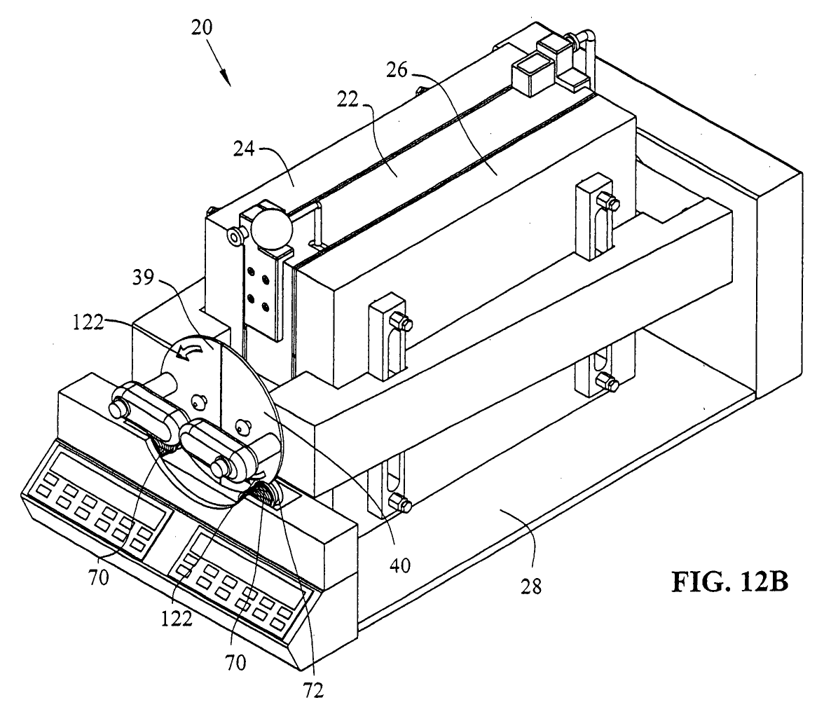

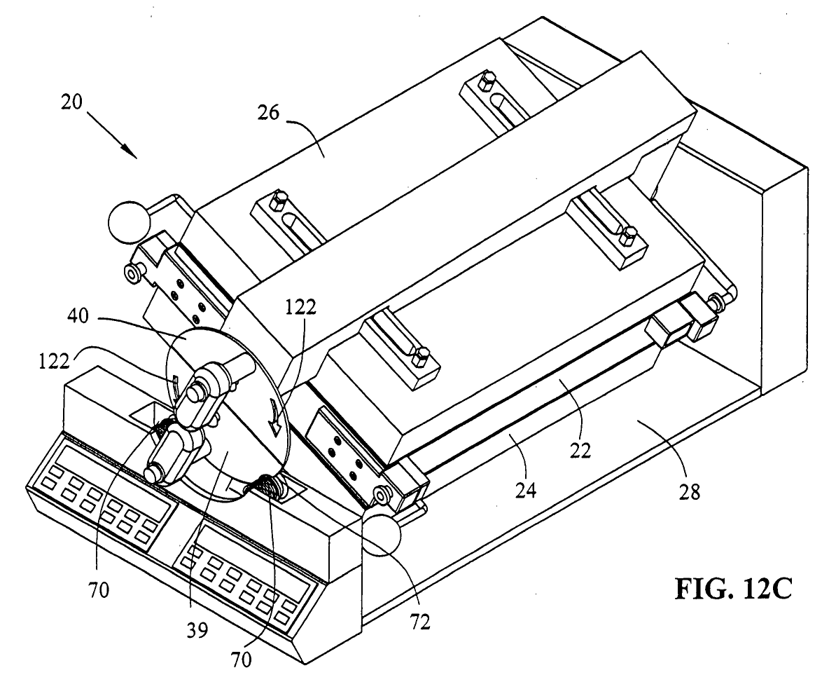

When the operator pulls the handles 42, 44, central waffle iron section 22 moves forward relative to base 28. Referring now to FIG. 11, the forward movement is depicted in which it can be seen pins 164 disengage apertures 152. This disengagement of the pins allows central waffle iron section 22 to be rotated about bearing (154 in FIGS. 8 and 9). The rotation of the dual level waffle iron 20 about the bearing 154 is depicted in FIGS. 12A-12C, which results in second cover 26 being located at the top of the waffle iron apparatus 20 and first cover 24 being located on the bottom of the waffle iron apparatus 20. It should be appreciated that the front portion of the waffle iron 20 is supported continually through the rotation via the engagement of handle plates 39, 40 with grooved rollers 72, as the handle plates 39, 40 are substantially planar when both cover members 24, 26 are closed.

It should be appreciated that arrow indicators 122 located on the handle plates 39, 40 indicate the direction of rotation which is possible for dual level waffle iron 20. Also, as will be appreciated, the waffle batter located between first cover 24 and central waffle iron section 22 continues to cook through the rotation of the waffle iron assembly about the bearing. When pins 164 align again with apertures 152, the force of springs 70 and spring 158 (depicted in FIG. 8) will cause the pins 164 to again engage apertures 152 preventing further rotation of central waffle iron section 22. Furthermore, a pair of stoppers 344 extend forward from the rear portion 150, with one of the stoppers 344 each being located on opposing sides of the perpendicular bearing 154. In addition, a contact 346 extends rearward of the yoke 118. The contact 346 and the stoppers 344 are located such that when the waffle iron assembly is rotated about the perpendicular bearing 154, the stoppers 344 will make contact with the contact 346 at the point when the pins 164 are aligned with the apertures 152 so as to prevent the central waffle iron section 22 from either over rotating, or being rotated in the wrong direction.

Once the waffle iron has been arranged such that second cover 26 is located on the top of the waffle iron 20, the previous steps detailing the filling of the cavities 60 and the cooking of the waffle batter in first cover 24 may be repeated with second cover 26, including using the electronic assembly 30 to monitor the cooking temperature and time associated with second cover 26. When the grid array located between second cover 26 and central waffle iron section 22 has been filled with waffle batter, the operator need only wait until either first indicator light 46 or second indicator light 48 blinks, indicating a completed cooking cycle. Once either indicator light 46, 48 begins blinking, the operator orientates the proper cover 24, 26 upwards corresponding to the lit indicator light which is located on the top of the dual level waffle iron 20.

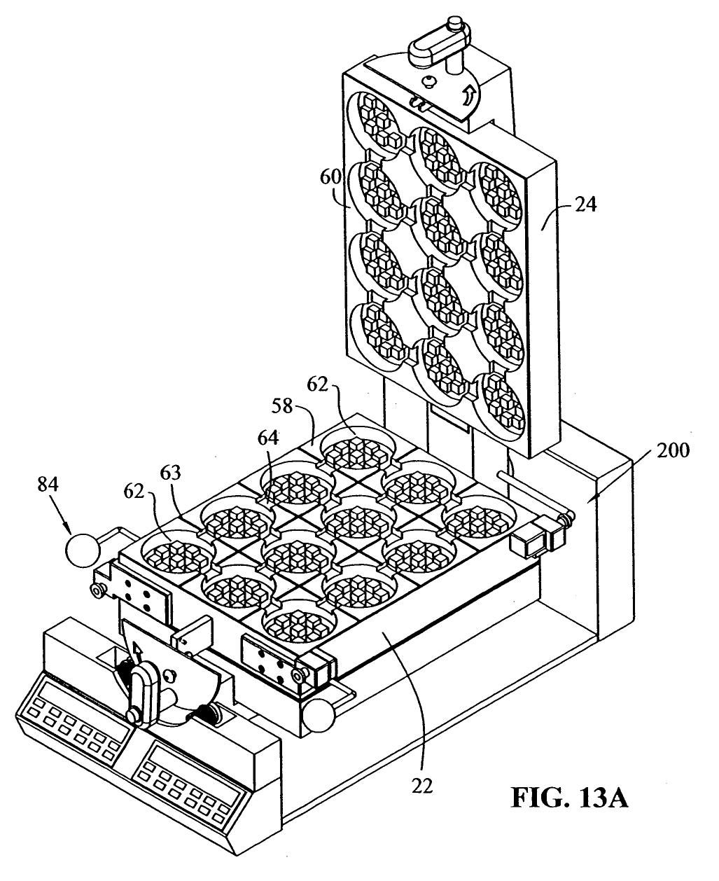

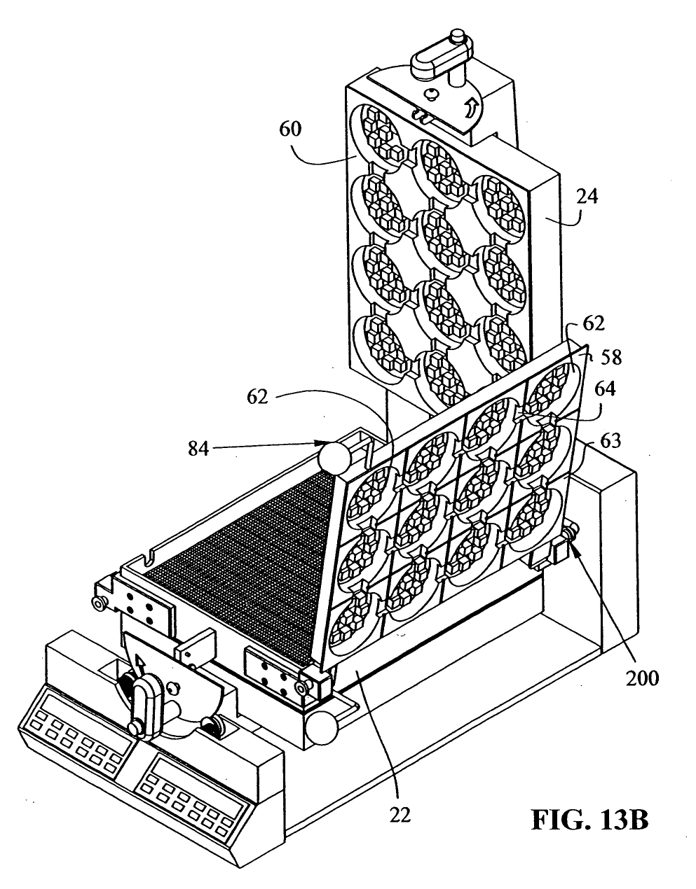

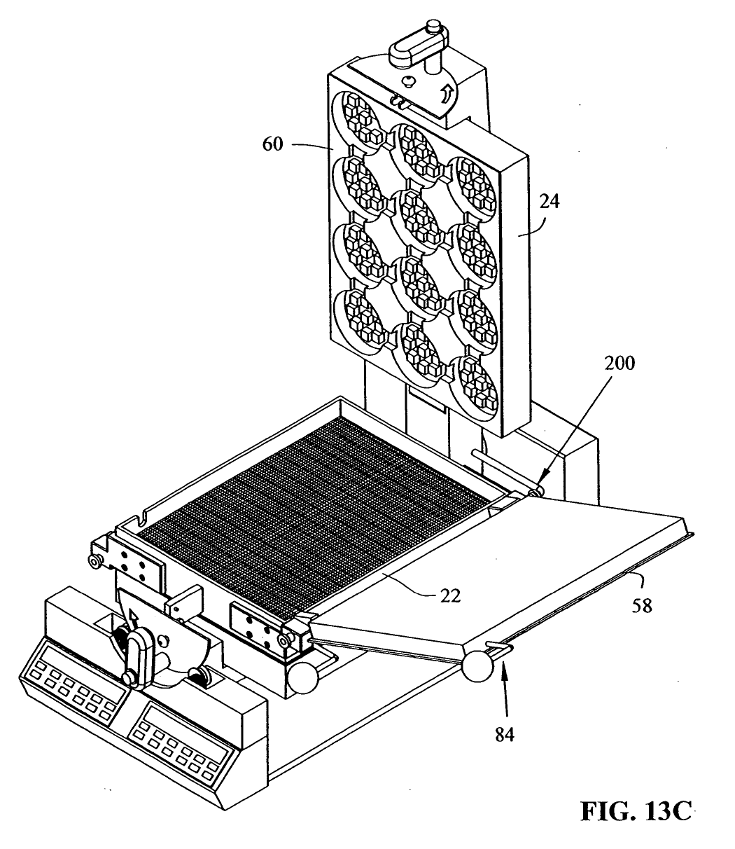

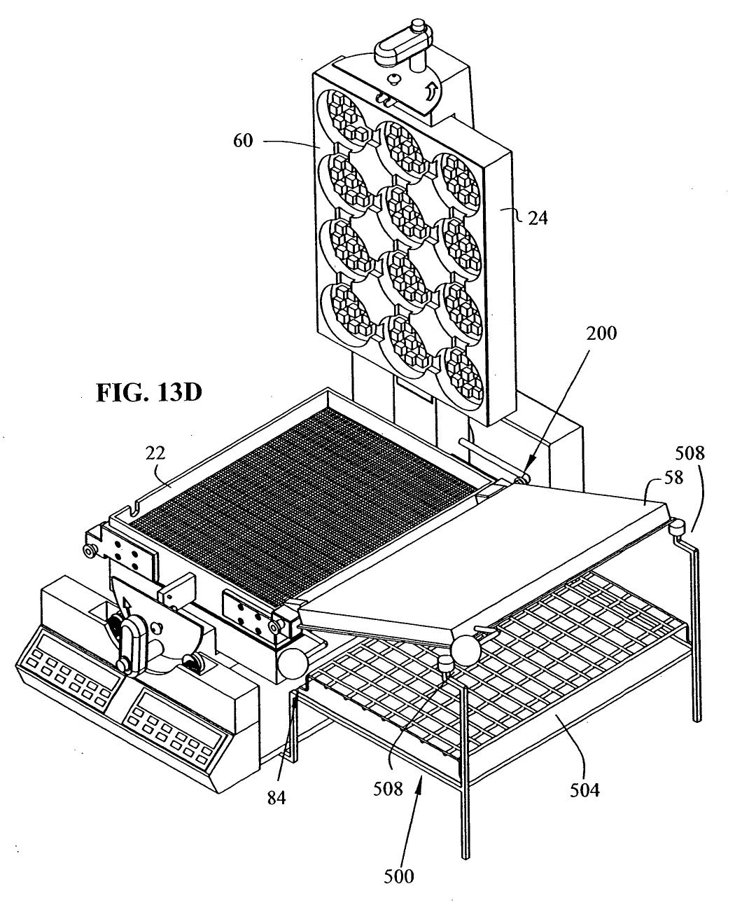

Once the cover associated with the completed cooking cycle has been orientated upwards, the operator then again depresses button 92, allowing the cover to be raised. Due to the gravity, the non-stick cooking surface associated with the second grid array 60 located within the raised cover, and the grooves 63, the cooked waffles should reside solely within the cavities 62 and channels 64 of first grid array 58 located on central waffle iron section 22. It should be noted that due to the presence of channels 64 in first grid array 58, the waffles are joined together as a web of waffles. The operator may separate the web of waffles into individual waffles using a cutting tool 300, to be described below, which may be guided by grooves 63 in separating the waffles. Once the waffles have been cut, the operator may then utilize knob 84, rotating first grid array 58 about first grid hinge assembly 200, as is depicted in FIGS. 13A-13D, dropping the waffles onto steam pan frame 500. It should be noted that first grid array 58 comes into contact with stops 508 of steam pan frame 500 in order to more easily free up the waffles which were cooked therein. Further, as first grid array 58 rotates on hinge assembly 200, bearing shafts 208, 216 do not rotate, but rather casting extension 210 and electrical box 214 rotate as each engages first grid array 58. Rather, bearing shafts 208, 216 remain stationary as the bearing shafts 208, 216 engage the mounting brackets 206.

At this time, if the operator would like to serve the waffles immediately, the waffle web may be separated into individual waffles of traditional sizes. However, if needed, the waffle web may be stored on the rack at room temperature, as storing the waffles in a cool cabinet tends to make the waffles soggy, whereas storage of the waffles under a heat lamp causes the waffles to dry out. Furthermore, if a heat lamp is not available, the waffles may be stored on the rack and then reheated in the waffle iron assembly 20 as desired. Electronic controls 20 may also include a setting for timing and temperature allowing for the quick re-heating of the web of waffles (not shown). Once the web of waffles has been reheated, the web may be separated into individual waffles in the manner described below.

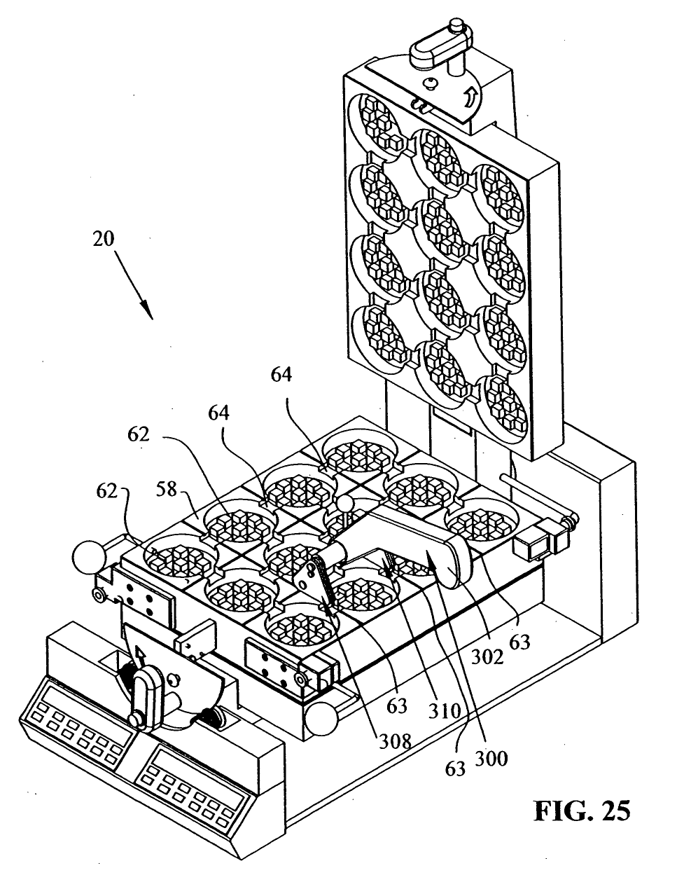

Referring now to FIG. 25, the use of cutting tool 300 will now be explained in detail. As discussed above, the end result of preparing waffles using the dual level waffle iron 20 is a web of waffles comprising a waffles baked within the cavities 62 inter-linked with batter located within the channels 64 while baking. The cutting tool is utilized to separate the individual waffles at the joints represents by the batter which had run into the channel 64 when leveling.

The cutter is designed such that the distance from first cutting assembly 308 to second cutting assembly 310 approximates the distance between grooves 63 present within first grid array 58. This allows the cutting tool to travel along first grid array 58 with the cutting wheels 328 (shown in FIG. 15) present within grooves 63. The operator may grip cutting tool 300 at the handle 302 and roll the cutting tool 300 through the groves 63 from one edge of first grid array 58 to the other. This movement of the cutting tool 300 along the grooves allows the cutting wheels 328 to separate adjacent waffles quickly and easily, as needed. In order to separate all the waffles from one another, the operator need only take the cutting tool 300 and roll it in any manner such that all of the grooves are traversed by the cutting wheels 328. It should be noted that when the cutting tool 300 is cutting adjacent waffles at the channels 64, straight movement of the cutting tool 300 is accomplished by the guides 326 (shown in FIG. 15), ensuring that as the cutting wheels 328 travel through the relatively open channel 64, the cutting wheels 328 will stay aligned with the groove 63 located on the other side of the channel 64. Furthermore, the extension of the pins 164 through the apertures 152 allows first grid array 58 to function as a working surface while cutting with the cutting tool 300 by preventing the undesired rotation of the central waffle iron section 22.

While this invention has been described as having an exemplary design, the present invention may be further modified within the spirit and scope of this disclosure. The application is, therefore, intended to cover any variations, uses, or adaptations of the invention using its general principles. Further, this application is intended to cover such departures from the present disclosure as come within known or customary practice in the art to which this invention pertains.

What I claim is:

1. An improved dual level waffle iron apparatus comprising:
a first pair of waffle grids comprised of a first center grid and a first rotatable grid;
a second pair of waffle grids comprised of a second center gird and a second rotatable grid;
said first and second center grids being located proximate each other; and
means for rotating said grids about the longitudinal axis of said dual level waffle iron apparatus;
wherein said first center grid and said second center grid include a plurality of waffle cavities and a plurality of channels, said channels extending between each pair of adjacent said cavities.

2. The improved dual level waffle iron apparatus as set forth in claim 1, wherein said first center grid and said second center grid further include a plurality of grooves located between adjacent said cavities.

3. The improved dual level waffle iron apparatus as set forth in claim 2, wherein each of said grids include twelve of said cavities.

4. The improved dual level waffle iron apparatus as set forth in claim 2, wherein said first center grid and said second center grid are attached to a central waffle iron section by a plurality of hinges along one edge, said grids being rotatable about said hinges during unloading.

5. The improved dual level waffle iron apparatus as set forth in claim 4, wherein said first and said second center grid further includes a knob located opposite said hinges, said knob providing a means for rotating said grid about said hinges.

6. The improved dual level waffle iron apparatus as set forth in claim 5, further including an unloading frame having a support and a steam pan, said support raising said steam pan to a level allowing the contents of said grid to drop into said steam pan following rotation of said gird about said hinges.

7. The improved dual level waffle iron apparatus as set forth in claim 6, wherein said unloading frame further includes a stop, said stop providing a means for dislodging the contents of said cavities from said grid.

8. The improved dual level waffle iron apparatus as set forth in claim 7, further including a first cover member located proximate said first rotatable grid and a second cover member located proximate said second rotatable grid wherein each of said waffle iron assemblies further includes an air spring, said air spring being capable of supporting said cover member in a substantially vertical position and slowing the speed of said cover member travels while closing.

9. The improved dual level waffle iron apparatus as set forth in claim 8, further including a means for adjusting the distance between said center grids and said rotatable grids.

10. The improved dual level waffle iron apparatus as set forth in claim 9, wherein said means for adjusting the distance includes a plurality attachment assemblies, each said attachment assembly including a first nut cup, a second nut cup, a spring, and a bolt, said spring supplying a force upon said cover member thereby reducing the separation distance between said rotatable grid and said center grid.

11. The improved dual level waffle iron apparatus as set forth in claim 10, further including an elongated handle allowing the operator to grip said handle during the rotation of said first and said second iron assemblies about the longitudinal axis.

12. The improved dual level waffle iron apparatus as set forth in claim 11, further including a pair of arrows, said arrows indicating to the operator the direction of rotation about the longitudinal axis in which said grids travel.

13. The improved dual level waffle iron apparatus as set forth in claim 12, further including a first indicator light and a second indicator light, said first indicator light indicating when the contents of the first set of grids have completed a cooking cycle, said second indicator light indicating when the contents of the second set of grids have completed a cooking cycle.

14. The improved dual level waffle iron apparatus as set forth in claim 13, further including an electronic control panel having a first display and a second display for monitoring the cooking time of the waffle batter, said first display and said first indicator light each including a first indicator and said second display and said second indicator light each including a second indicator, said first and said second indicator allowing the operator to determine which of said indicator lights corresponds to which of said displays.

15. An improved dual level waffle iron apparatus comprising:
a first horizontal waffle iron assembly having a cover member, a first frame, a central waffle iron section, and a pair of waffle grids comprised of a first center grid and a first rotatable grid;
a second horizontal waffle iron assembly having a cover member, a second frame, a central waffle iron section, and a pair of waffle grids comprised of a second center grid and a second rotatable grid;
said first frame having a means for opening and closing said cover member relative to said central waffle iron section of said first waffle iron assembly;
wherein said first frame and said second frame each include a means for varying the vertical distance between each said rotatable grid and each said center grid while said cover member is closed.

16. The improved dual level waffle iron apparatus as set forth in claim 15, wherein said means for varying the vertical distance between said first grid and said second grid comprises an adjustment mechanism including a bolt, a first nut cup, a second nut cup, a sleeve, and a spring, said bolt extending through said frame with a first end of said bolt being coupled to said rotatable grid and a second end of said bolt being retained by said sleeve, said spring being retained between said first end and said second end.

17. The improved dual level waffle iron apparatus as set forth in claim 15, further including a yoke and a base, said yoke coupling said central waffle iron section to said base wherein a plurality of pins extend from said yoke and engage a plurality of dimples in said base for preventing the undesired rotation of said yoke.

18. An improved dual level waffle iron apparatus comprising:
a first horizontal level waffle iron assembly;
a second horizontal level waffle iron assembly;
a yoke coupling said first waffle iron assembly to said second waffle iron assembly;
a base for supporting said yoke and allowing said yoke to rotate about the longitudinal axis of said waffle iron apparatus; and
a mechanism for preventing the rotation of said yoke about the longitudinal axis of said dual level waffle iron.

19. The improved dual level waffle iron apparatus as set forth in claim 18, wherein said mechanism includes a plurality of pins and a plurality of dimples.

20. The improved dual level waffle iron apparatus as set forth in claim 19, wherein said pins are located in said yoke and said dimples are located in said rear portion.

21. The improved dual level waffle iron apparatus as set forth in claim 19, wherein said pins are spring loaded.

22. The improved dual level waffle iron apparatus as set forth in claim 20, further including a spring providing a force upon said yoke, said force directing said yoke toward said rear portion.

23. The improved dual level waffle iron apparatus as set forth in claim 18, wherein said base further includes a roller assembly having a plurality of grooved rollers and a plurality of springs, said grooved rollers supporting a portion of said first or said second waffle iron assembly, said springs providing a force in the direction to cause said yoke to engage said rear portion.

24. The improved dual level waffle iron apparatus as set forth in claim 23, further including a means for adjusting the distance from said first grid array to said second grid array when said first cover member is closed.

25. A dual level waffle iron assembly, comprising:
a central waffle iron section, having upper and lower grids;
an upper cover portion movable to cover said upper gird, having a grid complementary with said upper grid;
a lower cover portion movable to cover said lower grid, having a grid complementary with said lower grid; and
a latching mechanism independently latching said upper and lower cover portions to said central waffle iron section.
